(19) United States
(12) Patent Application Publication
(10) Pub. No.: US 2022/0300598 A1
(43) Pub. Date: Sep. 22, 2022

(54) METHODS AND APPARATUS FOR INTERFERING WITH AUTOMATED BOTS USING A GRAPHICAL POINTER AND PAGE DISPLAY ELEMENTS

(71) Applicant: SunStone Information Defense, Inc., Los Gatos, CA (US)

(72) Inventor: David K. Ford, Los Gatos, CA (US)

(73) Assignee: SunStone Information Defense, Inc., Los Gatos, CA (US)

(21) Appl. No.: 17/608,909

(22) PCT Filed: May 5, 2020
(86) PCT No.: PCT/US2020/031472

§ 371 Date: Nov. 4, 2021

Related U.S. Application Data
(63) Continuation-in-part of application No. PCT/US2019/014495, filed on Jan. 22, 2019.
(60) Provisional application No. 62/843,742, filed on May 6, 2019.
(60) Provisional application No. 62/619,690, filed on Jan. 19, 2018.

(51) Int. Cl. G06F 21/36; G06F 3/04812; G06F 16/954

(52) U.S. Cl. CPC G06F 21/36; G06F 3/04812; G06F 16/954; G06F 2221/2133

(57) ABSTRACT

Methods and apparatus for interfering with automated bots using a graphical pointer and page display elements are disclosed. In an example, a processor selects a challenge for display on a client device. The challenge includes a display element and stylized pointer information. The processor causes the display element to be displayed on the client device and a pointer to be stylized, as specified by the pointer information. The processor receives a response message corresponding to at least one of a pointer selection or pointer movement made by the stylized pointer. The processor compares information within the response message to a specified correct location of the display element that is stored in an answer file related to the selected challenge. If the information within the response message is correct, the processor transmits a correct answer message and/or enables webpage content to be displayed or otherwise provided to the client device.

### PRIORITY CLAIM

This application is a National Stage of International PCT Application No. PCT/US2020/031472, filed May 5, 2020, which claims priority to and the benefit of U.S. Provisional Patent Applications No. 62/843,742, filed on May 6, 2019, the entirety of which are incorporated herein by reference.

International PCT Application No. PCT/US2020/031472 is a continuation-in-part of International PCT Application No. PCT/US19/14495, filed on Jan. 22, 2019, which claims priority to and the benefit of U.S. Provisional Patent Applications No. 62/619,690, filed on Jan. 19, 2018, the entirety of which are incorporated herein by reference.

### BACKGROUND

A pointer is one of the most ubiquitous aspects of computing. It is displayed as a graphic that changes locations within a display area based on inputs received from a mouse or similar input pointing device. Pointer properties, such as appearance and movement characteristics, are defined within a pointer file or specified in application code. The pointer properties are used by an operating system or application of a computer to display/move a pointer on a screen or within a display area. The pointer file also defines a “hot spot”, which includes an active pixel or a group of pixels within a pixel area for the pointer graphic. Selection of a pointer causes a location or coordinates of the hot spot to be returned as the selected location on a screen.

Currently, some websites provide a test to determine whether a user is a human or a computer (e.g., an automated bot). The test may include a completely automated public turing test (e.g., “CAPTCHA”) for differentiating computers from humans. Websites use CAPTCHAs as a security feature for providing accessing to a database, submitting a search query, purchasing a product/service, viewing requested content (e.g., multimedia content), etc.

Common CAPTCHAs today include a display of different pictures in a grid. A prompt instructs a user to select squares or fields in the grid that contain certain items, such as cars, bicycles, sidewalks, traffic signals, trees, buildings, etc. Many times the items are not clearly visible within the picture. The goal of the CAPTCHA is to provide images that are easily recognizable by a human user but difficult for a computer or bot to quickly decipher. For instance, a human user instantly understands what a car looks like and can identify images that contain cars, including images where the car is partially blocked from view or shown at various angles. In contrast, a computer has to apply one or more computer-vision or machine-learning algorithms that compare different profiles of cars to different items in the image to identify potential matches. Oftentimes, a computer or bot is not able to adequately identity all of the squares in a grid that contain a specified item, or at least make an identification within a reasonable time to pass the CAPTCHA.

Overtime, bot designers optimize bots to improve CAPTCHA performance. Bot designers have easily increased computing power, especially in distributed environments, to decrease the time needed to identify items in CAPTCHA pictures/challenges. In addition, bot designers have refined machine-learning algorithms to include artificial intelligence components that provide more accurate and faster completions of CAPTCHAs. As a result of the bots improvements, currently known CAPTCHAs may not be adequate.

### SUMMARY

The present disclosure provides a new and innovative system, method, and apparatus for detecting or interfering with bots or other automated malicious applications using a graphical pointer in conjunction with displayed page elements. The example system, method, and apparatus are configured to provide a challenge, tuning test, or CAPTCHA to a user of a webpage, application, database, etc. The turing test is relatively easy for a user to answer but extremely difficult or impossible for a computer or automated bot to solve within a relatively short amount of time.

The turing test disclosed herein includes the use of a pointer file that changes an appearance of a pointer from an arrow to a graphical representation of another object. Examples include a soda can, a beer bottle, a game controller, sunglasses, a hat, a bird, a dog, etc. As one can appreciate, the examples of graphical representations are virtually endless. The turing test also includes or specifies a page display element, such as a picture or video. The page display element is configured to have coordinates or other location information. For a given challenge, the example system, method, and apparatus determine coordinates that satisfy or solve the challenge and coordinates that correspond to an incorrect answer. The coordinates for solving a challenge for a given display element are selected beforehand based on the image or video selected for display, and how display element relates to the graphical representation of the pointer.

The display element, as disclosed herein, may include a scenery picture, a picture of a person, such as an actor or musician, a picture of multiple people, etc. Again, as one can imagine, the possibilities for a display element are virtually endless. The display element may be selected in coordination with the graphical representation of the pointer and a challenge provided to a user. The challenge includes one or more instructions that requests a user to move the pointer to a certain location on the display element. The requested location is configured to be easily discernable by a user but extraordinarily difficult for a bot or malicious application to answer. The challenges represent acquired internal human knowledge that is not easily parameterized by a computer.

In an example, the system, method, and apparatus may select a display element of a musician with their arms outreached. For this display element, a system operator (or a configuration server) created a challenge by changing a pointer file to show a soda can pointer, and specifying a textural prompt to “Give the musician a soda”. The operator or server determines that an allowable or correct response comprises a pointer hot spot that is on or around one of the hands of the musician that is shown in the display element. Human users are quickly able to understand the challenge and accordingly move in a matter of seconds the soda can pointer to the musician's hand that is shown in the display element. By contrast, a computer or bot has to first determine what the prompt even means before being able to determine which items in the display element are to be located. The bot also has to determine what item the graphical representation of the pointer represents as part of the solution for the challenge. Altogether, a computer or bot may need at least 30 minutes to multiple hours to solve the challenge, which would far exceed website timeout thresholds for receiving an answer.

In some embodiments, the challenge (e.g., a CAPTCHA challenge) may include multiple pointer selections. For example, the challenge may instruct a user to move the pointer to a first location. After receiving a successful response, the challenge may include instructing the user to move the pointer to a second location. In some of these instances, the graphical representation of the pointer may change to increase the variability of the challenges. For example, after successfully placing a soda can in a musician's hand, a pointer file is updated by the example system, method, and apparatus to cause the pointer to appear as a hat. The challenge may prompt the user to place the hat on the same musician or another musician that is pictured in the same display element or a different display element. Having at least two separate challenges further increases the difference between the time it takes a human to solve the challenges compared to the time needed by a bot or other malicious application.

The example system, method, and apparatus may further complicate the challenge for a bot by causing at least portions of a display element to change in response to a pointer hover or movement. For example, the system, method, and apparatus may cause at least a portion of a display element to zoom in, zoom out, animate, change to a different displayed element, change a display of an item within the display element, and/or uncover or make transparent a first image or color to reveal an underlying image. The change in display of at least a portion of the display element is readily discernable by a user but extremely difficult for a bot or other malicious application to process. Further, pointer movement can be tracked to determine if the movement is a rigid, smooth straight line, which is indicative of a bot, or if the movement is uneven or inconsistent, which is indicative of a human user.

Aspects of the subject matter described herein may be useful alone or in combination with one or more other aspect described herein. Without limiting the foregoing description, in a first aspect of the present disclosure, a bot security apparatus includes a memory device and a security processor. The memory device stores a plurality of challenge files for determining if a webpage user is a human or a bot. Each of the challenge files include a display element, a user prompt, pointer information, and a location of the display element that corresponds to a correct response. The security processor is communicatively coupled to the memory device and is configured to receive an indication message that a webpage of an application server is to be transmitted to a client device. The security processor is also configured to select a challenge file from the memory device, and transmit at least some information from the challenge file to cause the display element and the user prompt to be displayed on the client device and a pointer to be changed as specified by the pointer information. The security processor is further configured to receive a response message corresponding to at least one of a pointer selection or pointer movement made by the changed pointer at the client device in relation to the display element, and compare information within the response message to the location corresponding to the correct response for the selected challenge file. If the information within the response message matches or is included within the location corresponding to the correct response for the selected challenge file, the security processor is configured to transmit a correct answer message. If the information within the response message does not match or is not included within the location corresponding to the correct response for the selected challenge file, the security processor is configured to transmit an incorrect answer message.

In accordance with a second aspect of the present disclosure, which may be used in combination with any other aspect listed herein unless stated otherwise, the indication message is received from the application server or a load balancer and includes an identifier of a generic challenge that is related to the webpage, and the challenge file selected by the security processor corresponds to the generic challenge and the at least some of the information from the challenge file is transmitted to the application server or the load balancer for replacement of the generic challenge.

In accordance with a third aspect of the present disclosure, which may be used in combination with any other aspect listed herein unless stated otherwise, the indication message is received from the application server and includes the webpage and a generic challenge, the challenge file selected by the security processor corresponds to the generic challenge, and the security processor replaces the generic challenge with the at least some of the information from the challenge file and transmits the at least some of the information from the challenge file to at least one of the client device or the application server.

In accordance with a fourth aspect of the present disclosure, which may be used in combination with any other aspect listed herein unless stated otherwise, the security processor transmits the correct answer message to the application server, which causes the application server to at least one of transmit the webpage to the client device, transmit a second webpage to the client device, or transmit content related to the webpage to the client device.

In accordance with a fifth aspect of the present disclosure, which may be used in combination with any other aspect listed herein unless stated otherwise, the security server transmits the incorrect answer message to the application server, which causes the application server to at least one of terminate a connection to the webpage with the client device, terminate a session with the client device, or block the client device.

In accordance with a sixth aspect of the present disclosure, which may be used in combination with any other aspect listed herein unless stated otherwise, the incorrect message includes at least some information from another challenge file that is selected by the security processor for display on the client device.

In accordance with a seventh aspect of the present disclosure, which may be used in combination with any other aspect listed herein unless stated otherwise, the display element and the user prompt are displayed in the webpage or in a popup window over the webpage.

In accordance with an eighth aspect of the present disclosure, which may be used in combination with any other aspect listed herein unless stated otherwise, the display element is specified in at least one of an image file, a video file, an audio file, a multimedia file, a Java file, or a plug-in file, and the display element shows at least one item comprising a person, an animal, a character, a scene, or a vehicle.

In accordance with a ninth aspect of the present disclosure, which may be used in combination with any other aspect listed herein unless stated otherwise, the display element includes instructions that cause at least part of the shown item to change in appearance in response to a mouse-over or hover by the pointer in relation to a location of the item shown in the display element.

In accordance with a tenth aspect of the present disclosure, which may be used in combination with any other aspect listed herein unless stated otherwise, locations of the display element are specified by coordinates and the location of the correct response includes at least one of a coordinate or a set of coordinates.

In accordance with an eleventh aspect of the present disclosure, which may be used in combination with any other aspect listed herein unless stated otherwise, the pointer information includes at least one of a pointer file or instructions for changing properties of the pointer at the client device.

In accordance with a twelfth aspect of the present disclosure, which may be used in combination with any other aspect listed herein unless stated otherwise, the pointer information is specified to correspond to the respective display element of the challenge file.

In accordance with a thirteenth aspect of the present disclosure, which may be used in combination with any other aspect listed herein unless stated otherwise, a machine-accessible device has instructions stored thereon that, when executed, cause a machine to at least select a challenge for display on a client device, the challenge including a display element, a user prompt, and stylized pointer information that corresponds to the display element, provide the challenge causing the display element and the user prompt to be displayed on the client device and a pointer to be stylized as specified by the pointer information, receive a response message corresponding to at least one of a pointer selection or pointer movement made by the stylized pointer at the client device in relation to the display element, compare information within the response message to a specified correct location of the display element stored in an answer file or field that is related to the selected challenge, if the information within the response message matches or is included within the specified correct location stored in the answer file or field, provide a correct answer message, and if the information within the response message does not matches or is not included within the specified correct location stored in the answer file or field, provide an incorrect answer message.

In accordance with a fourteenth aspect of the present disclosure, which may be used in combination with any other aspect listed herein unless stated otherwise, the challenge or the answer file or field includes a time threshold, and the machine-accessible device has instructions stored thereon that, when executed, cause the machine to at least start a timer when the challenge is provided, if the response message is received before the elapsed time of the timer has reached the time threshold, perform the comparison that uses the information within the response message, and if the elapsed time of the timer has reached or exceeded the time threshold, determine the challenge was not successfully completed and provide at least one of the incorrect message or a timeout message.

In accordance with a fifteenth aspect of the present disclosure, which may be used in combination with any other aspect listed herein unless stated otherwise, the challenge or the answer file or field includes a click threshold, and the machine-accessible device has instructions stored thereon that, when executed, cause the machine to at least receive sequential multiple response messages, each response message including a location of the pointer during a pointer selection, perform the comparison using the information within the earliest, sequentially received response messages that are below or meet the click threshold, and disregard the response messages that sequentially exceed the click threshold.

In accordance with a sixteenth aspect of the present disclosure, which may be used in combination with any other aspect listed herein unless stated otherwise, the response message includes an identifier of the selected challenge, and wherein the identifier is used to determine the answer file or field for the comparison that uses the information within the response message.

In accordance with a seventeenth aspect of the present disclosure, which may be used in combination with any other aspect listed herein unless stated otherwise, the machine-accessible device has instructions stored thereon that, when executed, cause the machine to at least determine a generic challenge related to at least one of a webpage or online content for the client device, select the challenge based on the generic challenge, and cause the generic challenge to be replaced with the selected challenge.

In accordance with an eighteenth aspect of the present disclosure, which may be used in combination with any other aspect listed herein unless stated otherwise, the machine-accessible device has instructions stored thereon that, when executed, cause the machine to at least provide at least one of the correct answer message or the incorrect answer message to an application server that at least one of (i) hosts the webpage or the online content for the client device, or (ii) transmits the webpage or the online content to the client device.

In accordance with a nineteenth aspect of the present disclosure, which may be used in combination with any other aspect listed herein unless stated otherwise, the generic challenge includes metadata identifying content for the challenge, and wherein the challenge is selected based on the metadata.

In accordance with an twentieth aspect of the present disclosure, which may be used in combination with any other aspect listed herein unless stated otherwise, the content identified by the metadata includes at least one of advertising content, a person's name, a product brand, or a challenge type.

In accordance with an twenty-first aspect of the present disclosure, which may be used in combination with any other aspect listed herein unless stated otherwise, providing the correct answer message causes at least one of a webpage or content to be provided to or displayed on the client device.

In accordance with an twenty-second aspect of the present disclosure, which may be used in combination with any other aspect listed herein unless stated otherwise, any of the structure and functionality illustrated and described in connection with FIGS. 1A to 30 may be used in combination with any of the structure and functionality illustrated and described in connection with any of the other of FIGS. 1A to 30 and with any one or more of the preceding aspects.

Additional features and advantages of the disclosed system, method, and apparatus are described in, and will be apparent from, the following Detailed Description and the Figures.

### BRIEF DESCRIPTION OF THE FIGURES

The accompanying drawings, which are incorporated in and constitute a part of this specification, show certain aspects of the subject matter disclosed herein and, together with the description, help explain some of the principles associated with the disclosed implementations.

FIG. 1A illustrates an example of a pointer within a pixel image file representative of a type of image file painted by an operating system onto a monitor of a client device at a typical periodic update time (e.g. 60 Hz.).

FIG. 1B illustrates a data file tailored by an application window (e.g. browser), in which an arrow icon and an operating system (“OS”) hot spot are not collocated, according to an example embodiment of the present disclosure.

FIG. 2 illustrates a pointer event located by the OS, in which the hot spot coordinates are passed to an application window within a display of a computer screen, according to an example embodiment of the present disclosure.

FIG. 3 illustrates a computer screen having an application window in which an application provides a tailored pointer data file image with properties and actions under the control of the application, according to an example embodiment of the present disclosure.

FIG. 4A illustrates how an authorized visual user selects a sign in button using a tailored pointer data file image, according to an example embodiment of the present disclosure.

FIG. 4B illustrates how an unauthorized malware user is detected when attempting to select the sign in button of FIG. 4A, according to an example embodiment of the present disclosure.

FIG. 5 illustrates a flowchart of a method to identify a click as either valid or potential malware, according to an example embodiment of the present disclosure.

FIG. 6A illustrates a trajectory of a pointer by an authorized visual user in an application window, according to an example embodiment of the present disclosure.

FIG. 6B illustrates a trajectory traced by the OS hot spot as malware or an unauthorized non-visual user performs the actions from FIG. 6A with the look-a-like pointer, for which the final location of the OS hotspot is not over a “Checkout” button, according to an example embodiment of the present disclosure.

FIG. 6C illustrates the difference in trajectories traced by a local authorized user of FIG. 6A and a malware user of FIG. 6B, according to an example embodiment of the present disclosure.

FIG. 7 illustrates an application of a tailored pointer in accordance with some implementations, according to an example embodiment of the present disclosure.

FIG. 8 illustrates an alternative implementation of an application of a tailored pointer, according to an example embodiment of the present disclosure.

FIG. 9 illustrates a flowchart of a method to identify a click as either valid or potential malware, according to an example embodiment of the present disclosure.

FIG. 10 illustrates another implementation of an application of a tailored pointer, in which one or more pointer locks are used, according to an example embodiment of the present disclosure.

FIG. 11 illustrates a flowchart of an implementation of an application of a tailored pointer, in which one or more pointer locks are used, according to an example embodiment of the present disclosure.

FIG. 12 illustrates another implementation of an application of a tailored pointer, in which one or more pointer locks are used for pointer positioning, according to an example embodiment of the present disclosure.

FIG. 13 illustrates another implementation of an application of a tailored pointer, in which a pointer is not drawn until the pointer is in motion, according to an example embodiment of the present disclosure.

FIG. 14 illustrates another implementation of an application of a tailored pointer, in which the tailored pointer appears as something other than a classical “arrow” icon, according to an example embodiment of the present disclosure.

FIG. 15 illustrates another implementation of an application of a tailored pointer, in which the pointer is defined as the “thing” in motion, according to an example embodiment of the present disclosure.

FIGS. 16 to 19 illustrate diagrams of an input device security environment, according to example embodiments of the present disclosure.

FIG. 20 illustrates a diagram of a procedure that is performed by servers of FIGS. 16 to 19 for transmitting content to a client device, where the content relates to at least one challenge, according to an example embodiment of the present disclosure.

FIG. 21 illustrates a diagram a database configured to store challenges for the input device security environment of FIGS. 16 to 19, according to an example embodiment of the present disclosure.

FIGS. 22 and 23 illustrate diagrams of user interfaces showing a webpage with challenge information, according to example embodiments of the present disclosure.

FIGS. 24 to 26 illustrate additional embodiments of user interfaces displaying challenge information, according to example embodiments of the present disclosure.

FIG. 27 illustrates an embodiment where a challenge is provided in an application (e.g., a plug-in or other software program) on a client device, according to an example embodiment of the present disclosure.

FIG. 28 illustrates an embodiment where a challenge is provided in an application (e.g., a video player) on a client device, according to an example embodiment of the present disclosure.

FIG. 29 illustrates an embodiment where a challenge is provided in a gaming application on a client device, according to an example embodiment of the present disclosure.

FIG. 30 illustrates an embodiment where a challenge is provided in a shopping application on a client device, according to an example embodiment of the present disclosure.

Like reference symbols in the various drawings indicate like elements.

### DETAILED DESCRIPTION

The present disclosure relates in general to a method, apparatus, and system for generating a graphical pointer, mouse cursor, image, or the like (generally, “pointer” or other graphical input element) in a browser window or application viewer of a graphical user interface of a computer (e.g., a client device), in a location that differs from a default location of a pointer generated by the computer's OS, both of which have movements controlled by a user controlled input device such as a mouse, a trackball, slider or the like. Hereinafter, the moved or displaced pointer is called a “tailored pointer”.

Reference is made throughout to the term “pointer”. A pointer is specified by a pointer file (or application code) that defines how a symbol or a graphic image is to be displayed within a pixel area on a computer screen to mirror or echo movements of a pointing device. A pointer file or application code includes properties that specify appearance information, such as shape, color, size, shadow, etc. A pointer file or application code also includes properties that specify movement information, such as responsiveness, lag, inversion, etc. A pointer file or application code may further define a pixel location or set of pixels that comprise a hot spot.

Reference is also made throughout to a pointer selection and pointer position. As disclosed herein, a pointer selection corresponds to an activation of an actuator of a pointing input device, such as a left or right-click of a mouse. A pointer selection corresponds to a hot spot location on a screen or within an application viewer. A pointer position corresponds to a location of a pointer on a screen or within an application viewer. A position of a displayed pointer may not necessarily be the same location as a hot spot if an offset is created between the displayed pointer and the hot spot.

Reference is further made throughout to the term “mouse”. A mouse includes a pointing input device that enables a user to specify a location of a pointer on a screen. The mouse may include a hardware device such as a touchpad, trackball, stylus pen, etc. The mouse may also include a touchscreen that enables a user to change a position of a pointer to enter mouse-like selections. The mouse may further include a virtual mouse that may include software that emulates mouse movement. For example, the virtual mouse may include a virtual track ball that is displayed within a touchscreen of a client device. The virtual track ball enables a user to move a pointer, including a stylized pointer within an application viewer by selecting different locations or sliding their finger along the track ball. While the user's finger is located at the track ball, the hot spot for pointer selection corresponds to the pointer location or a location that is an offset from the pointer.

### Tailored Pointer Embodiment

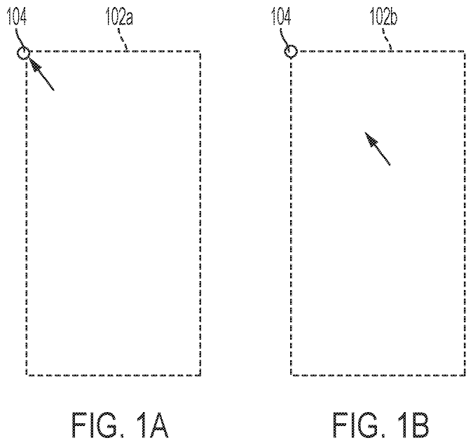

In some embodiments, the method, apparatus, and system are configured to interferer with automated bots (e.g., malware) using a tailored pointer in addition to the CAPTCHA tests described herein. FIG. 1A shows a diagram of a pointer data file 102a, which includes hot spot 104. The data file 102a includes a pixel area of 32×64 pixels. However, the viewable portion of the pointer itself may only comprise a portion of the pixel data, while the other portions are made transparent or hidden from view. The hot spot 104 is by default, typically defined to be the (0, 0) coordinate of the image. An operating system of a computer receives movement information from an input device and changes a position of the image file accordingly to reflect the user's movement.

At the time of a click event, the operating system of the computer identifies a location (e.g., screen or window coordinates) of the hot spot within the display area. The operating system then transmits the coordinates to an application that corresponds to the click event. The application executes program code based on a function defined at the coordinates of the click event.

Unbeknownst to many people, pointers can be manipulated remotely or locally by malware or malicious applications. Oftentimes, malware or malicious applications attempt to access secure webpages or data repositories by injecting pointer movement commends (e.g., commands designed to appear to originate from a pointing device) in connection with keyboard commands to an operating system of a computer or application on a server. In other words, the malware or malicious applications provide commands as though a user was entering commands through a trusted or validated computer as a way to access secure information. The malware or malicious application may be present on a user's computer or be located on a network and configured to intercept network traffic.

The example method, apparatus, and system are configured to generate a tailored pointer in connection with an offset between one or more application elements such as windows, buttons, scroll bars, text input fields, text, hyperlinks, images, etc. The application elements are configured to provide an application or webpage function that causes an application to perform one or more methods or a server hosting the application to perform one or more methods. The function may be defined to be located at coordinates of the application element such that a pointer selection of the element causes the function to be invoked. The application elements may include, for example, a “submit button” or an “ok button”, which when pressed by a user using a pointer device, causes information entered into an application (or otherwise related to the application) to be transmitted or processed. The application elements may also include hyperlinks or images, which when selected by a user using a pointer device, cause the application or a server to navigate to a different location or provide content associated with the hyperlink.

The offset generated by the example method, apparatus, and system may comprise a vector that is between a viewable version of the element and a hidden version of the element, where the hidden version is configured with the related function. The viewable version may comprise a graphical element without an underlying function or a security function that provides an indication of malware when selected. In some examples, the method, apparatus, and system may forgo creating a hidden version of the element and instead change a page location for the function such that it no longer coincides with a location in or related to the displayed element. As used herein, disclosure regarding the creation of a hidden element includes omitting creating an element and instead only moving a location of a selectable function.

The example method, apparatus, and system are also configured to create an offset between a graphical representation of a pointing input device, such as a pointer. The offset may be a vector that is between a hot spot of a pointer and a display of the pointer. The example method, apparatus, and system may be configured to modify or change a pointer file such that the pointer is displayed at the offset rather than being collocated with the hot spot. The offset for the application elements may be configured such that it is equal in magnitude and opposite in direction from the pointer offset. In some instances, pixel dimensions of the pixel file may be changed to increase the pixel area to permit greater degrees of offset. The relationship between the offset of the application elements and the pointer enables the pointer to be used by a legitimate user as though the offsets were not in place while at the same time interfering with malware's use of the pointer.

In some instances, the method, apparatus, and system may modify the pointer file to hide or make transparent a display of an OS pointer. The method, apparatus, and system may then create or modify a second pointer file (or a pointer definition specified in application code) or generate a graphical representation object at an offset from the OS pointer. The second pointer file may correspond to an application-level pointer or pointer file provided by a webpage that enables a host to change an appearance of a pointer or other pointer properties, including hot spot definition. The method, apparatus, and system may configure the second pointer file or object to track movement that is input by a user via an input device such as a mouse. The displayed graphic of the pointer and the hidden pointer may move in the same manner but an offset distance from either other, with the hot spot of the application pointer being set to equal or approximate the hot spot location of the OS pointer or equal or approximate an offset applied to application elements.

In some embodiments, the method, apparatus, and system disclosed herein are configured to operate on a client device. In these embodiments, the method, apparatus, and system create and apply the offsets locally for an application before application information is rendered. For example, the method, apparatus, and system may include a plug-in for a web browser or be configured as a stand-alone application. The method, apparatus, and system may also validate the user input locally. The method, apparatus, and system may transmit application data associated with the pointer selection to a server or host of the application if the pointer selection is deemed valid. Additionally or alternatively, the method, apparatus, and system may enable the application data associated with the pointer selection to be provided to the application for local processing if the pointer selection is deemed valid. The example method, apparatus, and system may further cause an alert or alarm to be displayed at the client device (or transmitted in a message to an application server) indicative that a pointer selection has been deemed invalid and/or a malicious application may have made the pointer selection.

In some embodiments, the method, apparatus, and system are configured to operate remotely from a client device. For example, the method, apparatus, and system may be configured within a proxy server between an application server and a client device. In other examples, the method, apparatus, and system are configured as a security feature within an application server. In these examples, the method, apparatus, and system are configured to generate and apply the offsets to the application (e.g., a webpage) before transmission to the client device. In addition, the method, apparatus, and system may update a pointer definition in the application code and/or remotely update the pointer file to apply the pointer offset. Further, the method, apparatus, and system are configured to receive responses from the client device including a location where a pointer selection was made to determine if the selection is valid. If valid, the method, apparatus, and system may transmit the application or page response information to the application server. If the response is invalid, the method, apparatus, and system may transmit an alert and/or alarm to the application server indicative of a presence of malware or a malicious application.

In some embodiments, the example method, apparatus, and system disclosed herein is configured to replace an OS pointer for a fake but realistic looking pointer with a predetermined displacement (and/or displacement function) within a graphical user interface, i.e. at a position that is different from the hot spot where the pointer is defined to be located by the OS. Soft information changes made to an application stack may be used to accommodate the displacement between imposed between OS and application versions of the pointer, where the “hard,” required functional programming of the session or application is preserved. For example, example method, apparatus, and system enables a user to fill out form data as the user intended, click to submit the form as intended using the pointer, and have the intended data submitted in a format specified by the server for transmission from a client device to a server that allows the intended functionality of the page to proceed. While the hard, required functional programming is preserved, the delta position of the pointer need not be revealed to the user. The soft information alterations that govern the pointer allow the user to operate the pointer as they intend to, and the page functions as before and to the same end. Hacking and automation tools (and other forms of malware) can be used to “drive” the OS pointer. However the changes made to the soft information in relation to the pointer and the page elements prevent the malware from operating as intended.

The soft information, as disclosed herein, includes changes to how data and graphics are displayed through an application viewed on a screen of a client device. The soft information may be changed within a pointer file and/or application program code (e.g., webpage code). Changes to the soft information do not change the intended functionality of the application or webpage. A first category of soft information includes methods and rules by which the original default OS pointer appears and is made to disappear. For example, the OS pointer may appear or disappear based on proximity to an edge of an application window. A second category of soft information characterizes how a replacement pointer is presented over time during a user's experience, including color, size, shape, and format. For example, pointer colors may be varied based on background, or set to a specific color. Pointer size may be set to 32×32, 64×64, or a different number of vertical and horizontal pixels in a square, rectangle, or other shape specified by a pointer file or application code. The pointer may be formatted as a .png, file, a jpeg file, a base 64 data string, or with another data format. The pointer may be built from canvas, SVG, javascript or any application window attribute with a graphical capability. This presentation may be constant or vary in time and/or position within a window, screen, or page.

A third category of soft information includes methods and rules for where the replacement pointer is positioned relative to the original OS pointer default hotspot. This displacement may be constant or vary in time and/or position within the window, screen or page. A fourth category of soft information governs how the replacement pointer responds to user input. For example, each degree of rotation of a trackball by a user may correspond to a certain number of pixels, such as 0.25, 0.5, 0.75, 1, 2, 3, 5, 10 or another number of pixels of pointer motion. This number may vary in time and position within the window, screen, or page. A fifth category of soft information governs how a replacement pointer interacts with other page elements, including input elements, buttons and links, as it hovers, mouse overs, clicks, mouse downs, or invokes other pointer events. The interaction may vary with the page element, time, and/or position within the window, screen, or page.

Some variations of soft information may break or disable browser functionality. For example, a pointer presented as a 1×1 pixel sized, transparently colored image would not permit a user to navigate within a web page, or interact with any features on that page. Another example of breaking browser functionality arises if pointer motion is altered so that one degree of rotation of a trackball corresponds to a random number of pixels in a random direction of pointer movement. Other soft information changes can break some applications but not others. For example, an all-white pointer would be visible on dark backgrounds, but not on white backgrounds.

Therefore, a final set of soft variations of the pointer element should allow the user to navigate the details of the page as they the user intend. In some instances, the example method, apparatus, and system disclosed herein may perform a verification of the soft information changes to confirm the application or page operates as intended. The method, apparatus, and system may make additional changes if initial soft information changes are determined to change operation of the application or page. In addition, other browser or application elements a page should be able to interact successfully with the pointer as required to permit a page to operate as designed. Moreover, it should be possible to generate the required response for a client browser and OS to send to a coherent, faithful description or summary of the user's intent and/or decision making process to the security device and application server.

This last set of soft variations are said to “preserve the hard information” of the web session. This hard information frequently changes with each page of the web session (for one page it may be that password information arrive at the server, for another page a user's seat selection for a concert ticket may be required by the server for the page to function as intended), but in each case it is minimally required that the server receive verification from the client device that the application's user and the web page elements (including the browsers pointer element, inputs, buttons, links, images, on-screen keyboards, icons, etc.) have interacted successfully to capture the application user's intent and send that information to the server.

The hard information as it relates to the pointer needs to be a coherent, faithful representation of required user input data, consistent with the user's intent. It can be directly or indirectly transmitted from the client device in a properly formatted manner to upstream devices such as a security proxy and application server. For example, if the user is given a floorplan of a concert hall, either the screen coordinates corresponding to seat 7A, or the text “seat 7A” may be transmitted. Once transmitted to upstream devices, user inputs may be processed, and in some cases proceed, to a next page of the application session.

When the soft information is applied to the page, functionality remains intact. The user is able to navigate the altered, modified page as required by the application and as the user intended. For example, if the user wanted to move the pointer to the left by 10 pixels, this can be accomplished with the application of the soft information. The user is able to navigate and provide inputs using the OS provided default keyboard, pointer clicks, trackball and touchscreen via the potentially modified page elements (including “fake” pointer, “fake” on-screen keyboards, “fake” inputs, buttons, forms, etc.), to cause their user's intent to be faithfully processed by the web page programming in the client device. The user is able to cause the transmission of required data for that page (example username and password are required for a login) in a properly formatted way to upstream servers.

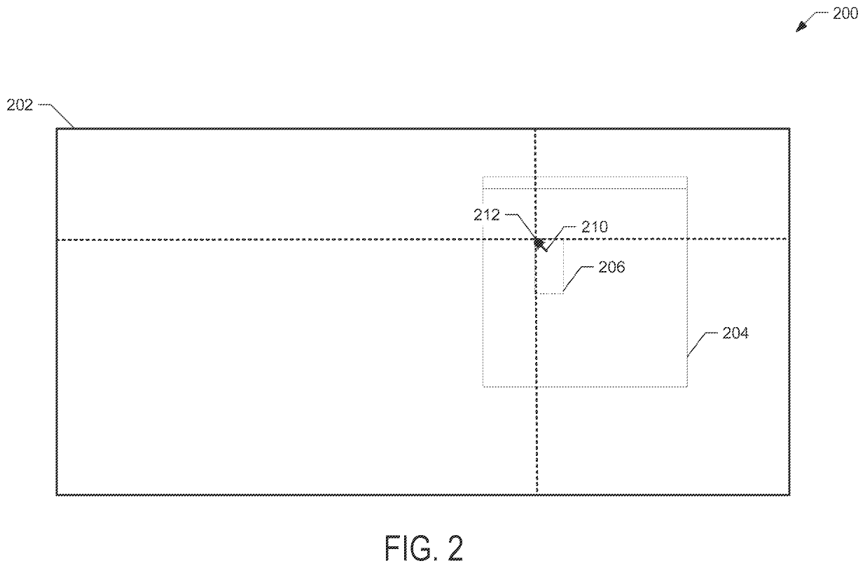

FIG. 2 shows illustrates a computer screen 202 (e.g., a display area) on a client device 200 having an application window 204 (e.g., an application viewer), and providing a tailored pointer data file image, or more simply “pointer” 206. In the illustrated example, the pointer 206 is configured such that a tip of a pointer 210 is collocated with a hot spot 212. User pointer selections are passed to the OS as the coordinates or location of the hot spot 212. The coordinates may include an x-axis value and a y-axis value of the screen 202 and/or the application window 204.

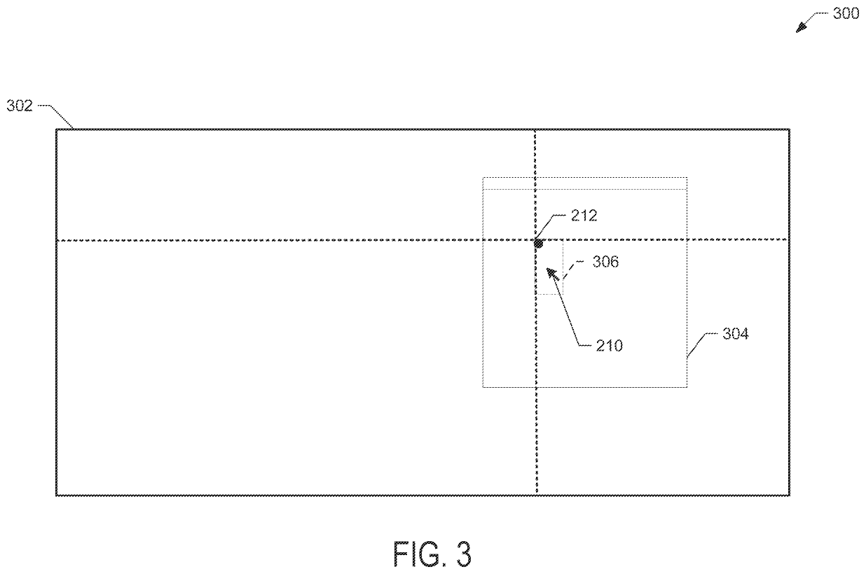

FIG. 3 illustrates a computer screen 302 on a client device 300 having an application window 304, and providing a tailored pointer data file image, or more simply “pointer” 306. The properties and actions of the tailored pointer are under the control of the application. In the illustrated example, the file 306 is modified such that the pointer 210 is displayed within a center of a pixel image. As such, a tip of the pointer 210 is no longer collocated with the hot spot 212. A distance between the pointer 210 and the hot spot 212 corresponds to an offset or offset vector.

The presentation information of the pointer 306 is a custom image together with its styling, positioning within the page, environment, sizing, and other presentation characteristics/properties. Response information governs how the pointer 306 (look-a-like pointer image) responds to user inputs. An example of response information is 1 degree of rotation of the user's trackball corresponds to a predetermined number of pixels of translation of the pointer 306. For example, one degree of rotation of the user's trackball can correspond to 1, 2, 3, 5, 10 or a different number of pixels.

Interaction information sets rules for how the pointer image interacts with other page elements for different pointer events, such as hover, mouse down, and mouse over actions. For example, the username and password information of a login screen that gets transmitted to a server is hard information, but aspects of how the fields are presented or how the pointer image interacts with page elements for different pointer event is soft information. Even after applying soft information a user needs to be able to navigate the page, fill in form data as intended, successfully click on appropriate page element(s), and send click coordinate information to a security engine to gain access to the next page of a web session.

The user expectation of the pointer 306 within the operating system default settings for the computer screen 302 can diverge from the default settings of the application window 304. The user expectation of the pointer 306 or icon location determines or leads to the user interaction with a page provided by the application window 304. The divergence (displacement or offset) allows for detection by the computer of a pointer generated by the operating system and pointer driver software (“OS pointer”) or pointer 306 guided by a human, via a computer input device such as a mouse, trackpad, trackball, keyboard, or the like. In other words, the pointer 306 generated by the application window 304 can diverge from a pointer generated by the operating system and pointer driver software for generating a pointer on the computer screen 302.

In some implementations, OS level malware may guide the hot spot 212 within the application window 304 according to operation system default parameters. Accordingly, a system can detect when such malware is being executed by using a divergence known to the application and its window. The divergence can be determined by the computer, and configured to be protective of application function.

FIGS. 1A and 2 illustrate an example of a pointer within 32x64 pixel image file representative of the type of image file painted by the operating system onto the monitor at a typical periodic update time (e.g. 60 Hz.). FIGS. 1B and 3 illustrates a data file tailored by the application window (e.g. browser), in which case the arrow icon and operating system (OS) hot spot are not collocated. In the example of FIGS. 1A, 1B, 2, and 3, the offset, a divergence or displacement between the OS and application pointers is the distance between the origin (0,0) in the default data file and (16, 22) in the tailored data file, indicating a horizontal displacement of 16 pixels and a vertical displacement of 22 pixels. Each of the vertical and horizontal displacements can be constant throughout the application window, or they can vary. In a first set of embodiments, the displacements are constant over at least a portion of an application window. In a second set of embodiments, the displacements vary as a function of location. In a third set of embodiments, the displacements vary as a function of time. In a fourth set of embodiments, the displacements vary as a function of time and location. The following paragraphs describe these four sets of embodiments.

In the first set of embodiments, the displacements in the horizontal and/or vertical dimensions are constant over a region within the application window, or over the entire application window. For example, the OS and application pointers may be displaced from each other by 1, 2, 3, 5, 7, 10, 15, 20, 25, 30, 40, 50, 80, 100, or a different number of pixels in the horizontal and/or vertical dimension. The number of pixels of displacement can be the same or different for the two dimensions over the region within the application window, or over the entire application window. Such constant displacements are known to the application, for example a browser, but may not be known to the operating system, and may not be known or predictable to an external malware agent.

In the second set of embodiments, the displacements (offsets) vary as a function of location. For example, the displacements in the horizontal and/or vertical dimensions can converge towards zero at edges of the application window, and have higher displacements away from the boundaries. The displacements may vary in the horizontal and/or vertical dimensions according to one or more sinusoidal or other geometric functions. The displacements may follow a linear, piecewise linear, curvilinear, or sinusoidal function, or any combination thereof. For example, the horizontal (x) and vertical (y) can be defined as: x_{offsec}=sin(wx/w), where w is the width of the browser window in pixels, and y_{offsec}=sin(wy/h), where h is the height of the browser window in pixels. This is just one representative function that may be applied to determine horizontal (x) and vertical (y) displacements. Other functions that, for example, are included in math libraries may be applied, such as absolute value, other trigonometric functions, logarithmic, power, exponential, random, and square root. Functions can be applied singly or in combination.

The displacements may be continuous functions, or may include jump discontinuities. The displacements may have one or multiple local minima and/or maxima within the application window. The displacements may be scaled by a randomized factor. The displacements may be discretized or rounded to an integer number of pixels. The displacements can be constrained to maximum and or minimum displacements with a region, or over the entire application window.

The functions, as well as the number of pixels of displacements, can be the same or different for the two dimensions over the region within the application window, or over the entire application window. Such functions and displacements are known to the application, for example a browser, but may not be known to the operating system, and may not be known or predictable to an external malware agent.

In the third set of embodiments, the horizontal and/or vertical displacements vary as a function of time. For example, the horizontal and/or vertical displacements can be adjusted or scaled based on the time since the window was painted, by a randomized time factor, or based on the current timestamp. Such temporal variations are known to the application, for example a browser, but may not be known to the operating system, and may not be known or predictable to an external malware agent.

In the fourth set of embodiments, the displacements vary as a function of both time and location, by combining aspects of the second and third sets of embodiments described above.

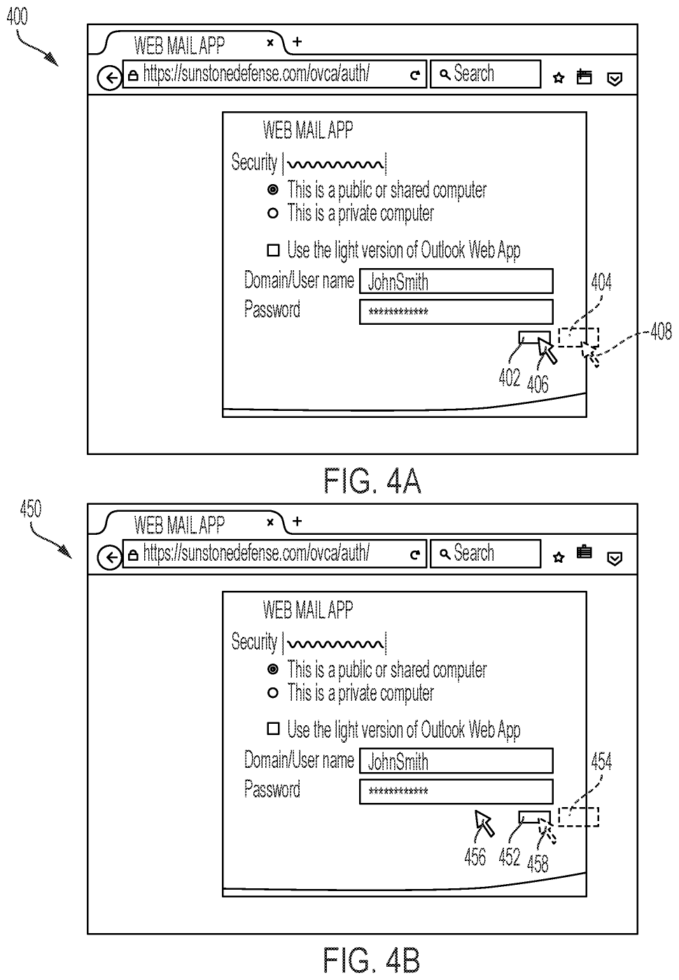

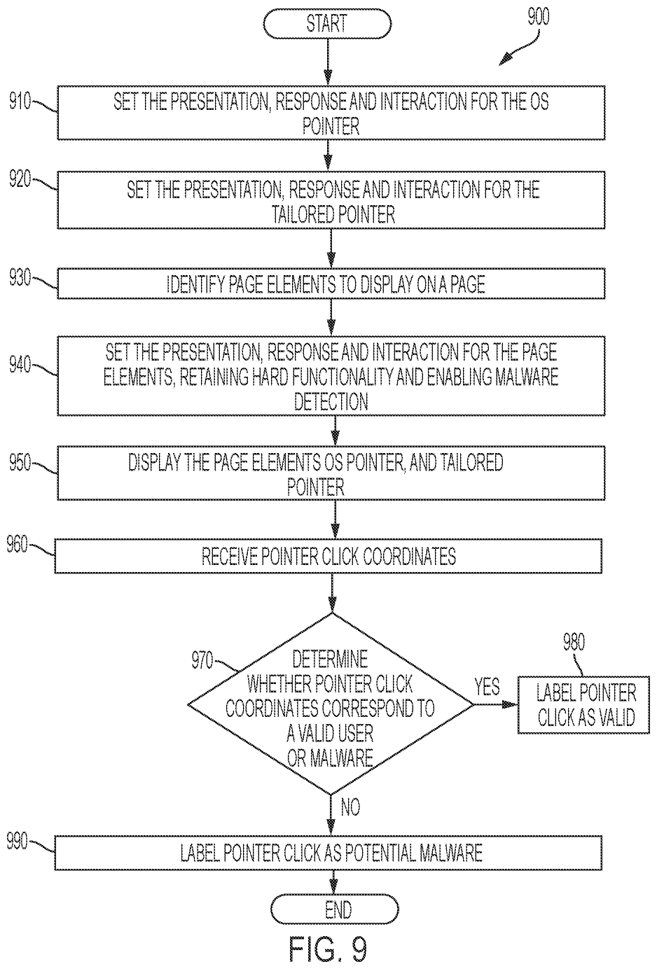

FIG. 4A illustrates how several sources of soft information changes depicted through reference numbers 402, 404, 406, and 408 are configured together so that hard information flow of the page is preserved and how an authorized visual user selects a sign in button using a tailored pointer data file image. The visual user sees the application pointer 406 (e.g., a tailored pointer) that was rendered by the browser to look like a pointer. The displaced operating systems pointer 408 is hidden (not displayed) by the browser, so that it is not visible to the user. In this example, the offset is between the pointer 408 and the tailored pointer 406. Similarly, the button 402 rendered by the browser is displaced from a hidden (not displayed) clickable button 404. The button 402 is displaced by the same distance as the displacement of the pointer 406. The hidden pointer 408 and hidden clickable button 404 correspond to step 940 of FIG. 9. Purposeful selections of soft information that when taken together with the soft information changes depicted in 402 and 406 all mesh together to enable page function and ensure that the hard information corresponding to the user supplied data inputs and other automatically supplied data field types, such as cookies and session ID numbers, are ultimately able to be transmitted and read by a server that provided the application or webpage 400 whenever the user is ready to transmit their data. The rendered application pointer 406 and button 402 are artifacts in the page 400 created by varying the soft information properties of the page's original OS pointer icon and form submit button displayed to the user in a style, color, or location that may vary without impacting the ability of the client device and server from exchanging the necessary hard information corresponding to required data as the client intended and within the original scope of the application's design. That is, in sum total, after all changes have been made, the web page functions. When the visual user moves the soft browser pointer 406 icon over the soft browser sign in button 402 and clicks the mouse, the invisible OS pointer 408 is over the invisible application sign in button 404 and activates the sign in the button 404 once the user (unknowingly) directs the OS pointer to send a click event at the location of the non-visible button 408. The user believes they have sent a click event at 402 using 406. As a result, the visual user successfully signs on.

In contrast, FIG. 4B illustrates how an unauthorized malware user selects a sign in button 404 using a tailored pointer data file image within an application 450. The unauthorized malware user does not know, a priori, that soft information changes 452, 454, 456, 458 have been introduced into the application 450. The soft information change depicted in pointer 458 causes the OS pointer to be rendered invisibly to the user. Soft information change depicted in pointer 456 causes a look-a-like pointer image to appear at a horizontal displacement from the pointer 458. Soft information changes depicted in hidden button (location of a selectable function) 454 alter the visibility of the page's original submit button to a non-visible state as well as introduce a displacement of the button from its original position by the same horizontal displacement adopted between pointers 458 and 456. Soft information change 452 introduces an image that looks like a button at the original position of the pages submit button. Taken together these soft changes preserve the functionality of the page and so ensure that the necessary hard information flow is preserved for the real user (FIG. 4A), and that the malware user is detected. There is a horizontal displacement between the OS pointer 458 and the application pointer 456. The malware user moves or drives the real OS pointer 458 over the fake (image replica) of a form sign on button 452. The location and possibly the styling of the original clickable button have been altered. The malware clicks on the picture of the button 452 with the OS pointer 458, which does not correspond to the location of the hidden OS button 454 (or function). As a result, the malware user is not able to sign in.

Therefore, after providing username and password credentials, the divergence between the OS and application window pointers may result in a user “clicking” on an empty section of the web page rather than the provided “Sign-in” button, or selection of a security element that triggers an alert. The substitution of the application level pointer and its divergence from the operating system pointer have actively caused malware to be detected. This type of detection is not made by passive observation and analysis of collected data but rather actively caused to happen by applying a simple understanding the intent of the authentication form (fill in fields, click the button) and the malware user's inability to navigate the substitution of pointers to complete the authentication process. In this example, the malware is defeated. Embodiments that randomize or vary the displacement, or take other measures described herein, make it more difficult for malware operate the system.

FIGS. 4A and 4B are therefore illustrative of implementations on modifying soft information: presentation information of the browser's pointer as a custom image supplied by the present invention (presentation of the OS pointer as non-visible), response information governing how the look-a-like pointer image responds to user, and interaction information regarding how the pointer image (the look-a-like submit button and displaced the original submit button) interact (hovers, mousedown, mouseovers, etc. are examples of this) with other page elements. These page elements may have been part of the original page or added to the page by the present invention for example the element 406. These soft alterations were specifically chosen in order that they work together in unison to preserve the original functionality of the page. Because the altered page logic fulfills the same roles as the original page logic one is assured that the hard information flow (for example the necessary site cookies, data fields, session tokens, etc., that are necessary for effective communication between client and server devices, and also fulfilling the intent of the server application) is also preserved. The username and password information example of FIGS. 4A and 4B are an authentication example in which the username and password information gets transmitted to the server as intended by the client. FIGS. 4A, 4B also illustrate how a button gets the click, or an input or password box gets the click. While the buttons in FIGS. 4A and 4B are login buttons, some embodiments of the disclosed technology use other buttons or other screen widgets. In some embodiments, the button can be a one-click ordering button to purchase an item. In some embodiments, the button can be replaced with an image of a triangle to be selected by a user to verify that user, as opposed to machine, interaction.

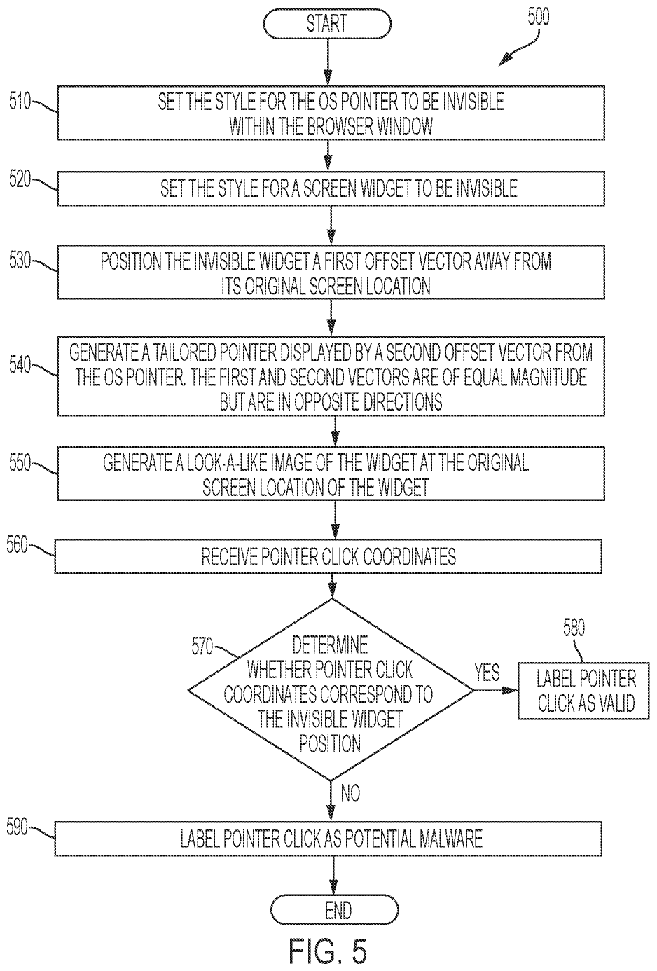

FIG. 5 is a flowchart of a method to identify a click as either valid or potential malware. Although the method 500 is described with reference to the flow diagram illustrated in FIG. 5, it will be appreciated that many other methods of performing the acts associated with the procedure 500 may be used. For example, the order of many of the blocks may be changed, certain blocks may be combined with other blocks, and many of the blocks described are optional. For example, additional or different blocks may be executed in embodiments where coordinates or a location of a function of an application or input device element are moved and/or a pointer file is modified to change a location of a displayed pointer within a pixel area.

The method 500 can be used to distinguish between the valid user of FIG. 4A and the malware user of FIG. 4B, described above. In block 510, method 500 sets the style for the OS pointer to be invisible within the browser window. FIGS. 4A and 4B illustrate the invisible OS pointer with dashed lines. In this example, method 500 uses a mouse to position a pointer on a screen. A trackball, keyboard command, touchpad, voice input, touchscreen, or equivalent forms of local user input can be used by method 500 to position a pointer on the screen.

In block 520, method 500 sets the style for a screen widget to be invisible. In the examples of FIGS. 4A and 4B, the screen widget is a button. Other screen widgets or page elements that can be used by method 500 include radio buttons, check boxes, split buttons, cycle buttons, sliders, list boxes, spinners, drop down lists, menus, and tool bars.

In block 530, method 500 positions the invisible widget (or function of an application), such as a button, a first offset vector away from its original screen location. For example, in FIGS. 4A and 4B, the invisible button is offset to the right of its original location by 30 pixels.

In block 540, method 500 generates a tailored pointer displaced by a second offset vector from the OS pointer. The first and second offset vectors are of substantially equal magnitude, but are in opposite directions. For example, in FIGS. 4A and 4B, the tailored pointer 406 and 456, respectively, is offset to the left of its original location by 30 pixels, of equal magnitude (30 pixels) and opposite direction (left vs. right) of the first offset vector. As the OS pointer 408 and 458, respectively, moves (invisibly), the look-a-like tailored pointer image 406 and 456, respectively, moves with it. As noted above with respect to FIGS. 1A and 1B, the offset vector can be of constant magnitude and direction, may vary as a function of position, may vary as a function of time, or may vary as a function of both position and time.

In block 550, method 500 generates a look-a-like image of the widget at the original location of the widget. In the example of FIGS. 4A and 4B, the widget is a sign-on button. In various embodiments, method 500 may apply a different style to the look-a-like image of the widget. The look-a-like image of the widget and the tailored pointer are “soft” information. By painting the look-a-like image of the widget at the original location of the widget, both valid users and malware users who capture a display screen will view the look-a-like image in the original location, even though the “real” invisible widget is offset from that location.

In block 560, method 500 receives pointer click coordinates. The pointer click coordinates may be from a valid local user, an authorized remote user, an invalid remote user, or malware user. Valid local users will click on a user interface, such as a mouse, trackball, touchpad, touchscreen, keypad, keyboard, or voice entry. Valid users will click when the tailored pointer 406 position corresponds to a location of the look-a-like widget 402. As a result, the invisible OS pointer 408 position will correspond to the position of the invisible widget 404. In contrast, an unauthorized remote user or malware unaware of the pointer offset would feed pointer positions to the OS pointer queue corresponding to the original widget position instead of the offset invisible widget position.

In block 570, method 500 determines whether the pointer click coordinates correspond to the invisible widget position. If they are, in block 580 method 500 labels the click as valid. If not, in block 590 method 500 labels the click as potential malware. Method 500 may return to step 560 one, several, or up to a threshold number of times before concluding a malware user is trying to gain access. Method 500 may label a click as potential malware if the pointer click coordinates correspond not only do not correspond to the invisible widget portion, but they do correspond to original screen location of the widget. In some embodiments, the method 500 may generate an alert and/or an alarm if a threshold numbers of times have been reached.

In some embodiments, the offset between the invisible OS pointer and the tailored pointer varies as a function of screen position (x, y) and time since the page was loaded (t). In some embodiments, the offset converges to 0 as the invisible OS pointer approaches a border of the browser window. This boundary condition does not impact the ability to detect malware; instead it provides a consistent viewing experience when crossing boundaries, as within the browser window the tailored pointer is visible, but outside of the browser window the OS pointer is visible. This boundary condition avoids sudden shifts in pointer location that could be used to predict offset values.

In addition to these and other position and time factors, the offset can be varied as a function of user action. For example, if the user moves the mouse quickly, method 500 can slow down the motion of the picture, to reduce sensitivity of the look-a-like picture motion to the OS motion. In some embodiments, the tailored pointer position can be changed as the user interacts with the application, for example by typing keystrokes, moving a mouse rapidly, scrolling the window, watching a video, or reading an article, pop-up or other page content. The disclosed technology takes advantage of the fact that a legitimate user may likely be distracted while performing certain (inter)actions. By having the pointer disappear from one location and reappear in another (or fading out and fading in) during these moments, it is simultaneously more difficult for malware to predict pointer position, and less burdensome with regard to the user experience of legitimate users.

In some embodiments, the style of the tailored pointer and/or the widget can be changed as a function of time or user action. For example, after five seconds of user inaction, which can be interpreted as the user being distracted or reading screen content, the tailored pointer can fade out, and reappear when the user moves (or “shakes”) the mouse, making it more difficult for malware to predict pointer position.

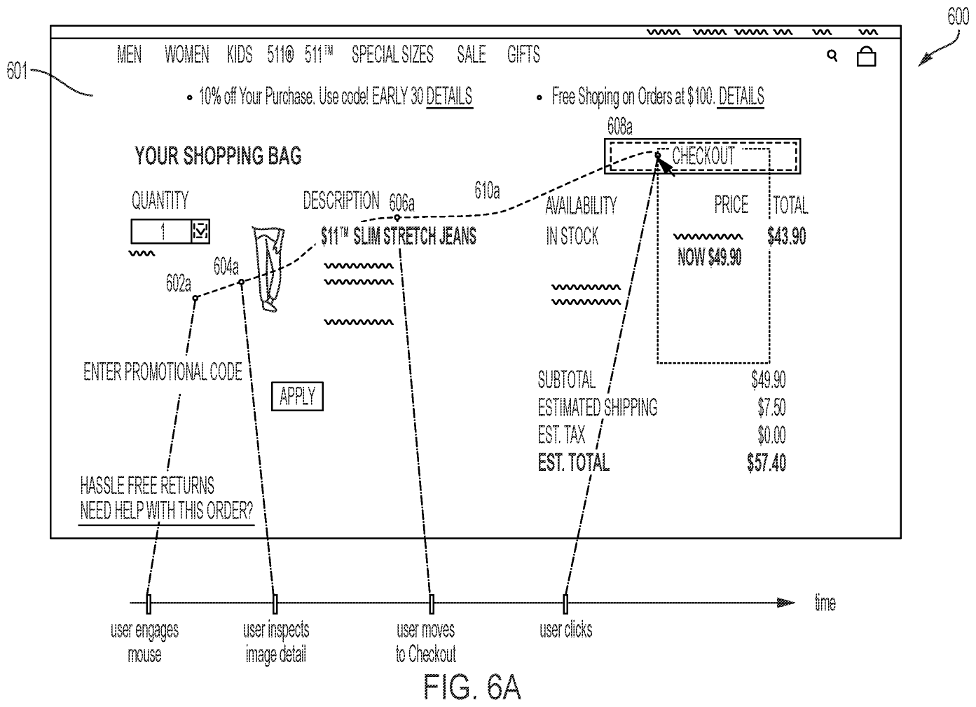

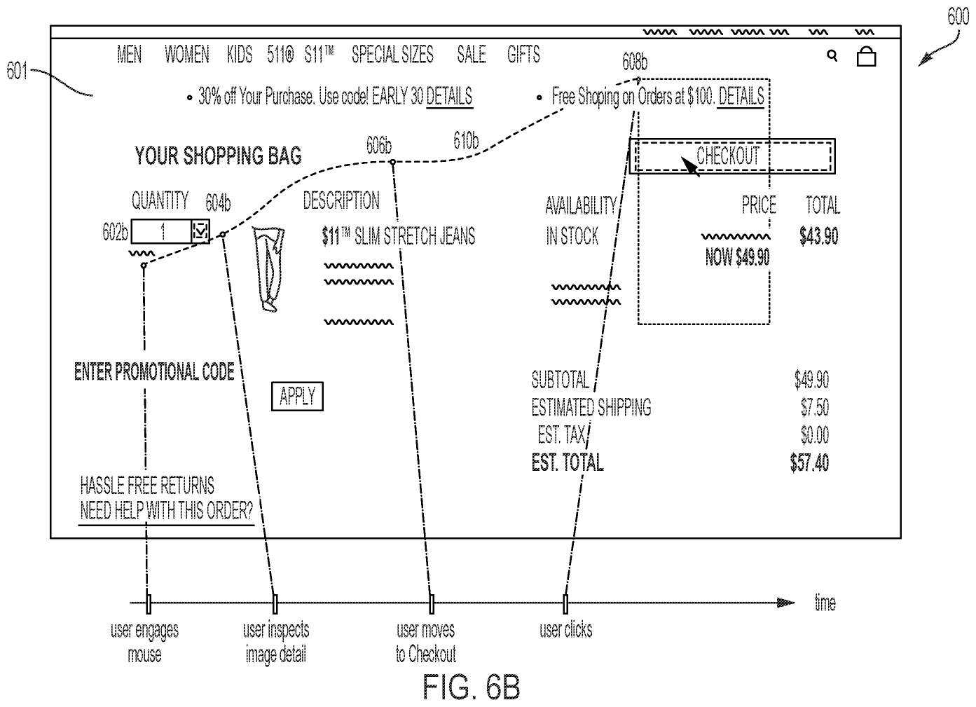

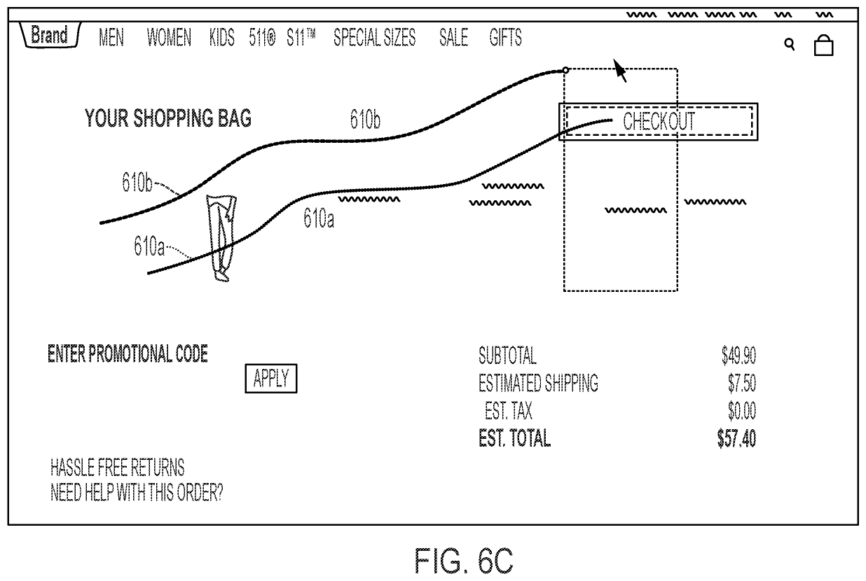

FIG. 6A illustrates a trajectory of a pointer by an authorized visual user in an application window 601 on a client device 600. In FIG. 6A, a typical human trajectory 610a for controlling a pointer in an application window 601 under default conditions by an operating system is shown. The application window 601 represents a typical e-commerce internet provided window generated in a webpage or other electronic transactional application. The trajectory 610a shown illustrates when a user engages the mouse (i.e. the pointer via an input device such as a mouse, trackpad, etc.) at 602a, inspects an image detail at 604a, moves to a “checkout” button (i.e. button, link or tab, etc.) at 606a, and then clicks on the final “checkout” button at 608a.

FIG. 6B illustrates the trajectory 610b traced by the OS hot spot as malware or an unauthorized non-visual user performs the actions from FIG. 6A with the look-a-like pointer, for which the final location of the OS hotspot is not over the “Checkout” button. Malware or other computer-implemented software may operate within the parameters of the operating system, while the application is actually running divergent to the operating system, such that the steps a user takes in the operating system would be offset from the steps necessary to take in the application window, and such that a misalignment of the malware of the pointer would be indicative of a computer-implemented malware process that is executing on the computer. The trajectory 610b shown illustrates when a malicious user or application engages the mouse/pointer via the OS at 602b, inspects an image detail at 604b, moves to a “checkout” button (i.e. button, link or tab, etc.) at 606b, and then clicks on the final “checkout” button at 608b.

FIG. 6C illustrates the difference in trajectories traced by a local authorized user of FIG. 6A and a malware user of FIG. 6B. FIG. 6C is an aggregate of the different pointer trajectories induced by the “tailored” pointer, where user behavior is tested invisibly, so as to indicate a potential non-human, computer-implemented malware process that moves the pointer. A human user operating the computer within the application would provide a pointer trajectory as shown in trajectory 610a, while a malware or automated program manipulating the pointer via the OS is shown in trajectory 610b. While these trajectories assume a common sensitivity, i.e., how far the pointer moves (1x, 2x, 10x, etc.) in response to ball rotation, the sensitivity parameter can be adjusted at runtime of the browser-generated and/or OS-generated pointer to provide a further divergence or delta in their respective movements within the graphical user interface. FIG. 6C also demonstrates the disclosed technology's ability to purposefully engineer an alteration of user telemetry data, as opposed to the passive observation of user telemetry data.

FIG. 6C illustrates a constant spatial offset between the OS pointer and the look-a-like replacement pointer. It graphically depicts what the pointer trajectory might look like over time when the constant spatial offset, previously shown in FIGS. 4A and 4B, is implemented. This constant spatial offset is an example variation of the soft information that may be used to create a malware detection scheme. The disclosed technology includes each of the other soft information variations described herein, both singly and in combination.

By drawing from multiple variations, a wide variety of detection methods are available to detect malware. These methods can be varied and chosen unpredictably, so that a malware user would not be able to predict the soft information variation. This is similar to a malware agent knowing that a password is required to enter a system, but not being able to predict a long and complex password because there are so many possibilities. The set of soft variations includes more than the examples of FIGS. 4A, 4B and 6C. It also include the (soft) presentation information variations, (soft) response to user information variations, and soft interaction with other page elements information variations. These variations may vary in time, with pointer position, and in response to each other.

The relative spatial offset can be constant, or vary as a function of time and screen position. Relative positioning may also vary based on the user interacting with other page elements. For example, the offset may change after the user begins using the keyboard. The way that the look-a-like pointer is styled or presented may vary in space and time, as well as based on user interaction with other page elements or user inputs via a keyboard, trackball, or mouse. Input controls that may be (soft) varied include pointer sensitivity settings, pointer momentum settings, pointer stickiness settings, and pointer lock settings. The way that the pointer is styled, positioned, responds or interacts may be based on the spatial trajectory the pointer has taken across the window, the elements interacted with as it traveled across the window.

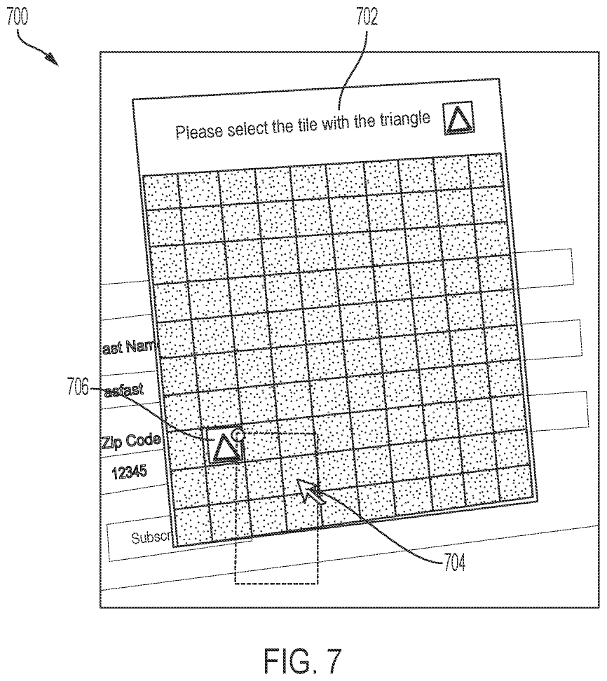

FIG. 7 shows an application of a tailored pointer in accordance with some implementations, in a program that protects websites from malware by requesting user behavior that cannot be accomplished by a computer programmed “bots,” such as is currently provided in the industry by a test known as a “Captcha.” As shown in FIG. 7, the graphical user interface 700 of a client device provides a test 702 with a familiar captcha like format (on purpose), but the challenge is not based on ability of AI to learn or recognize image based representations of “street signs”. The triangle image 706 is defined on the page and provided freely in the caption. The test is simply that there is a spatial (or time-based) delta between the OS and browser pointers 704. Therefore, users are not burdened with additional cumbersome questions to validate that they are legitimate users. They may not even be aware that they are being questioned, as in many embodiments they are using an application as they always have, as the application web pages are used by the disclosed technology.

A pop up window using at test as shown in FIG. 7 can be used for a variety of applications, without needing customization for different applications. For example a bank and a department store may have sign in buttons on the upper right and center of a web page. While these pages can be adapted using the disclosed technology, including tailored pointer and look-a-like widgets on in the upper right and center of their respective web pages. Position testing can be done using a separate pop-up page common to both the bank and the department store, such as the triangle selection window of FIG. 7.

As shown in FIG. 7, because the distance between the pointer 704 and the hot spot 706 may cause an undesirable user experience, keeping the pointer close is a convenient “fix”. If the pointer image remains close to the hot spot however not all of the 100 tile choices in the challenge shown can be utilized. One way to mitigate this is to apply a mathematical function with the defining property that the divergence between the OS pointer and application supplied pointer is at a maximum when the OS hot spot is located in the center of the application window and the divergence draws to a minimum as the OS hot spot approaches the boundaries of the applications window.

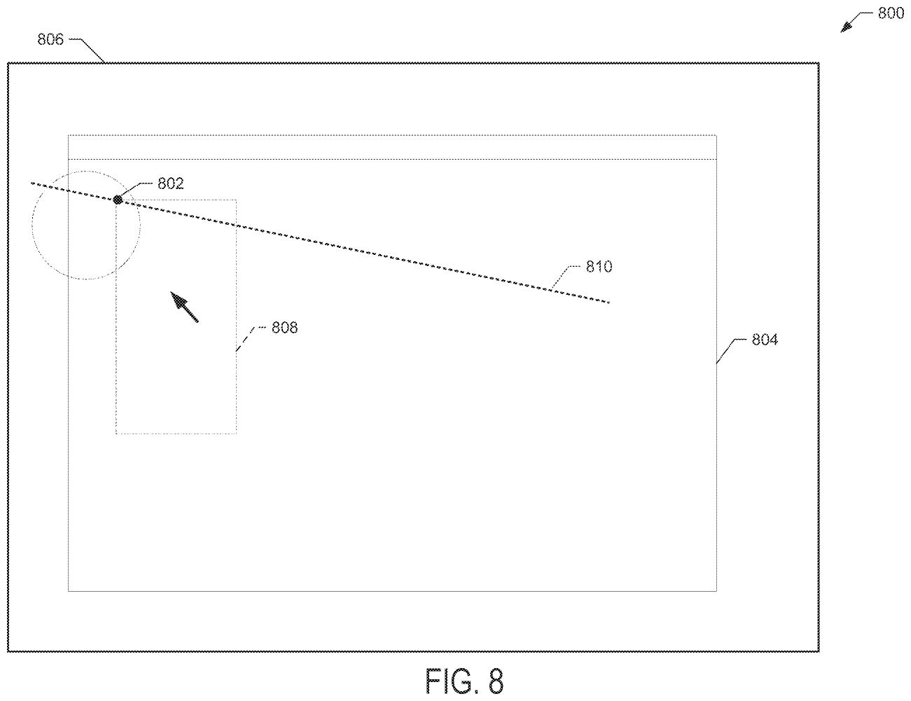

FIG. 8 shows an alternative implementation of an application of a tailored pointer. As the OS pointer hot spot 802 crosses the boundary of the browser window 804 into the OS “desktop” 806 of a client device 800, the browser loses its ability to control the pointer image 808. The OS pointer once again takes control. The user experiences an abrupt “jump” in the pointer movement as the border of the browser window is traversed, as it follows pointer trajectory 810. Examples where this may occur include when the user wishes to resize the browser window with the pointer, the user wishes to use the scroll bars in the browser window; or the user wishes to move the pointer into another application's window.

FIG. 9 is a flowchart of a method 900 to identify a click as either valid or potential malware. Although the method 900 is described with reference to the flow diagram illustrated in FIG. 9, it will be appreciated that many other methods of performing the acts associated with the procedure 900 may be used. For example, the order of many of the blocks may be changed, certain blocks may be combined with other blocks, and many of the blocks described are optional.

The example method 900 can be used to distinguish between a valid user and a malware user by modifying soft presentation information, soft response information, and/or soft interaction information for the tailored pointer. In block 910, method 900 sets the presentation, response, and interaction for the OS pointer. The pointer click coordinates may be from a valid local user, an authorized remote user, an invalid remote user, or malware user. Valid local users will click on a user interface, such as a mouse, trackball, touchpad, touchscreen, keypad, keyboard, or voice entry. Valid users will click when the tailored pointer 406 position corresponds to a location of the look-a-like widget 402. As a result, the invisible OS pointer 408 position will correspond to the position of the invisible widget 404. In contrast, an unauthorized remote user or malware unaware of the pointer offset would feed pointer positions to the OS pointer queue corresponding to the original widget position instead of the offset invisible widget position.

Method 900 sets the soft information of the page for the OS pointer inside the browser. Soft presentation information includes layout, color, size format, opacity, shape, iconography and other factors. Soft response interaction includes how it reacts to user input, user input rates, trackball rotations, as well as pointer sensitivity, momentum, stickiness, pointer lock, and keyboard inputs. The soft interaction information includes how the OS pointer interacts with other elements of the page, such as input boxes, links, buttons, page boundaries, images, and other page elements. The soft information for the OS pointer can be varied in ways that are not predictable to a malware user, but do not adversely impact the hard information and/or operation of the page. A malware user would not know what presentation, response and interaction for the OS pointer to expect, making it difficult for a malware user to spoof the application and enter valid information or select a valid entry with the correct coordinates. A trackball, keyboard command, touchpad, voice input, touchscreen, or equivalent forms of local user input can be used by method 900 to position a pointer on the screen.

In block 920, the method 900 is configured to set the presentation, response, and interaction for the tailored pointer. The soft presentation information for the “fake” tailored pointer includes layout, color, size, format, opacity, shape, iconography, position and other presentation aspects. The soft response information includes how the tailored pointer reacts to user input, user input rates, trackball rotations, as well as pointer sensitivity, momentum, stickiness, pointer lock, and keyboard inputs. The soft interaction information includes how the tailored pointer interacts with other elements of the page, such as input boxes, links, buttons, page boundaries, and images. The soft information for the tailored pointer can be varied in ways that are not predictable to a malware user, but do not adversely impact the hard information and operation of the page. A malware user would not know what presentation, response and interaction for the OS pointer to expect, making it difficult for a malware user to spoof the application and enter valid information or select a valid entry with the correct coordinates.

In block 930, method 900 identifies page or application elements to display on a page. Page elements correspond to screen widgets, such as textual information, images, input boxes, links, and buttons. Page elements can be added or deleted from the page in ways that are not predictable to a malware user, but do not adversely impact hard information and the operation of the page. The page elements may be modified by changing, adding, or removing application code for those elements. Therefore, the identified page elements may differ from the set of page elements from a known web application page, such as a bank's login page that has been in public use. The “body element” of the page lists and characterizes the elements that are included on the page, and reflects additions and deletions that occur in block 535. The malware user would not know what page elements are added or deleted from the page as expected, making it difficult for a malware user to spoof the application and enter valid information or select a valid entry with the correct coordinates.

In block 940, method 900 sets the presentation, response and interaction for the page elements, retaining hard functionality and enabling malware detection. Just as the OS pointer and tailored pointer have soft presentation, response and interaction properties, each page element has soft presentation, response and interaction properties that can be altered. The page elements include the images, buttons, borders, inputs, forms, canvases, div elements, and animations. Method 900 ensures that the soft information variations applied in blocks 910, 920, 930 and 940 operate together so that the web page and application still function as expected. For example, a valid user is able to enter data and interact with the page as desired, data can be entered in a manner acceptable to the client operation system, TCP stack, and technologies upstream to the client device, such as security proxies and an application server. This ensures that hard information and proper page functionality is preserved. Before and/or during the time that hard information is being gathered together, and sent to the application server, malware can be detected and a security device notified of malware activity. For example the location of a CLICK as the malware attempts to SUBMIT an authentication form may be engineered by suitable choices of presentation, response and interaction properties of the OS pointer, tailored pointer, and page elements, such that the CLICK location is different for human users than it is for malware “users”.

In block 950, the method 900 displays the page elements, OS pointer, and tailored pointer, according to the soft presentation, soft response, and soft interaction elements that are set in blocks 920, 930, and 940. Displaying includes presenting the page elements, and incorporating software corresponding to the soft response and soft interaction aspects of the OS pointer, tailored pointer and the page elements.

In block 960, method 900 receives pointer click coordinates. The pointer click coordinates may be from a valid local user, an authorized remote user, an invalid remote user, or malware user. Valid local users will click on a user interface, such as a mouse, trackball, touchpad, touchscreen, keypad, keyboard, or voice entry. Valid users will click based on the tailored pointer soft presentation, response, and interaction information. In contrast, malware unaware of the tailored pointer soft presentation, response, and interaction information would feed pointer positions to the OS pointer queue that does not take into account the soft tailored pointer information, making it possible to distinguish between valid users and malware users, in block 970.

In block 970, the method 900 determines whether the pointer click coordinates correspond to a valid user or malware. If they are, in block 980 method 900 labels the click as valid. If not, in block 990 method 900 labels the click as potential malware. Method 900 may return to step 960 one, several, or up to a threshold number of times before concluding a malware user is trying to gain access. Method 900 may label a click as potential malware if do not correspond to the expected location of a page element, but they do correspond to the original location of the page element before modification from application of the soft presentation, response and interaction properties.

In example embodiments, in block 910, method 900 may alter the OS pointer presentation to be just 1×1 pixel large, so that is barely visible. Method 900 may also alters the OS pointer response to user input by implementing pointer lock on the page. In block 920, method 900 may add a new look-a-like (tailored) pointer image to the page as an SVG element positioned to trail the motion of the OS pointer by, for example, 100 pixels to its left. The new look-a-like pointer may be programmed to disappear when the user moves the pointer over a pixel region or zone, such as a region a region containing an image, or a region near a page element border. Method 900 sets the interaction for the page elements, so that whenever the user engages the keyboard, method 900 adds a new SUBMIT button and a new div element to the body page element.

In these example embodiments, the first constraint of block 940 is that the page still functions and hard information is preserved. This can be accomplished by positioning the new submit button at the position of the original submit button. The second constraint of block 940, that malware can be detected, can be accomplished by the following steps. First, method 900 positions the original SUBMIT button 100 pixels to the right of its original location. Second, method 900 styles the original SUBMIT button to the same color as the background of the page at that shifted location, so that it is not visible to the user. Third, method 900 attaches a click listener to the new div. Fourth, method 900 makes the new div transparent, with a new div element the size of the original submit button. Fifth, method 900 places the new div element 100 pixels to the left of the original submit button. Sixth, method 900 attaches a click listener to the div element. Seventh, method 900 programs the click listener programmed to send an XHR request to a security device, so that when the malware moves the OS pointer to the position of the original submit button, the look-a-like pointer clicks on the new div element and the attached click listener transmits a warning packet to alert the security device. If the real user moves the fake pointer to the new SUBMIT button, the original non-visible OS pointer clicks on the displaced SUBMIT button and the form is submitted as before. In alternative embodiments, instead of moving the SUBMIT button, the method 900 may move a location of a submit function 100 pixels to the right of its original location. In other words, the method 900 moves a target area for the submit function from the SUBMIT button to instead another area of a webpage or application.

In other example embodiments, a malware script is configured to login/authenticate to a web service. The malware script injects stolen username password credentials into the login form, and attempts to “click” on the SUBMIT button associated with the login form for the web service. The malware may take note of the (x,y) coordinate position of the login button, and the (x,y) coordinate position of the pointer. The malware wishes to place the pointer over the SUBMIT button's location, and may direct a trackball to be rotated, or a pointer translated (or submit input device outputs to simulate pointer movement), so that the “click” action the malware performs takes place over the SUBMIT button. Although the malware can readily measure button location and OS pointer location coordinates, the malware does not know the pointer's soft response to user input settings, such as trackball sensitivity settings, pointer lock settings, pointer momentum settings, pointer stickiness settings, or other soft features. As a result, the malware will not be able to provide the correct instructions to move the pointer to the SUBMIT button position on the page. The mouse (pointer) click action will be in the wrong location, making it possible to determine that the resultant pointer click in not valid.

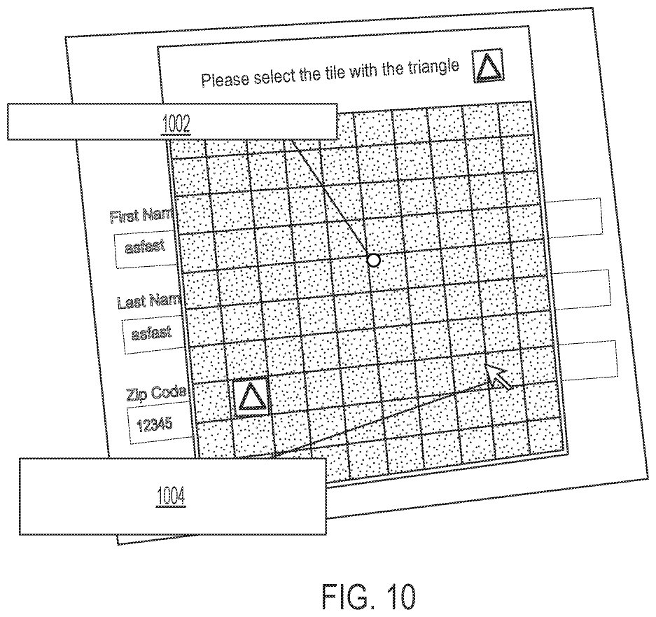

FIG. 10 shows another implementation of an application of a tailored pointer, in which one or more pointer locks are used. A pointer lock is a built-in browser feature included in HTML5 compatible and other browsers. The purpose of pointer lock is to enable web browsers as a platform for gaming, to keep the pointer from escaping the field of play of the game, especially in first person shooter games. The feature locks the pointer to the center 1002 of the browser window. Pointer move events are interpreted as commands for the shooters' perspective to rotate (look to the left or to the right in the 3D scenario, or to look up or down). Pointer lock is one of many browser features that can be specified by a web page developer, just as the OS pointer can be set (or styled) to be invisible at the discretion of the web developer. Such tunable page features alter the soft information on the page. Changes in soft features should be consistent with the hard information requirements of the page's intent and design. For example, it should be possible for the form to be filled out by a user, and submitted by the client hosting the page to a server.

The “border of the browser window boundary” transition problem never occurs because pointer lock prevents the pointer 1004 from going to the border. To return to normal pointer control the user may hit the ESC key or the game may also release the pointer by clicking the triangle as shown in the image. The browser runs in the operation system, and can have the capability to draw in the browser window. The browser “listens” to the OS pointer event queue and receives pointer coordinate information from the operating system. This information can be used to identify what browser element is “under” the pointer. For example, the browser may change the color of an element if it is being hovered over. When pointer lock is enabled, the browser exits the mode in which it only receives pointer information, and enters a mode of operation in which it also transmits pointer move requests. For example, the browser can insert a pointer move request into the OS queue to position the pointer at specific coordinates (such as (100,100)) of the browser window.

With pointer lock enabled, the browser both transmits and receives pointer movements from and to the OS. This information flow is a tunable application parameter of the soft information type as it does not directly impact the TCP stack data such as session ID's, cookies, HTTP POST or GET data fields, etc., and/or directly prohibit the user from effectively generating and transmitting data required for the application to function as intended to upstream internet devices. As with any soft information changes implemented by the present disclosure it is subject to the workflow outlined in method 900 to ensure that soft changes made to the application are counterbalanced and all mesh together to preserve required hard functionality. The goal of pointer lock is to keep the pointer position at a fixed position, such as the center, of the browser window. This prevents, for example, the pointer from exiting the browser window, for applications including video gaming. This also prevents users from inadvertently exiting a browser window when abruptly “yanking” the pointer in response to a surprise gaming event. The browser receives pointer coordinates from the operating system, and can display a tailored pointer in response to changes in pointer coordinates. While browsers typically only receive pointer coordinate information from the OS, with pointer lock a browser can transmit movement requests to the OS.

In some embodiments, a browser add-on or application software wrapper moves the OS pointer position to a position that is randomized and/or a function of time, OS pointer position, and/or dependent on user actions. This differs from traditional pointer lock implementations in which the OS pointer is positioned to a particular spot such as at the center of a window and not controllable or tunable by the web page or application page designer. Such enhanced pointer lock embodiments can be applied to specialized industrial environments, such as internal corporate networks, power plants and/or other industrial control applications.

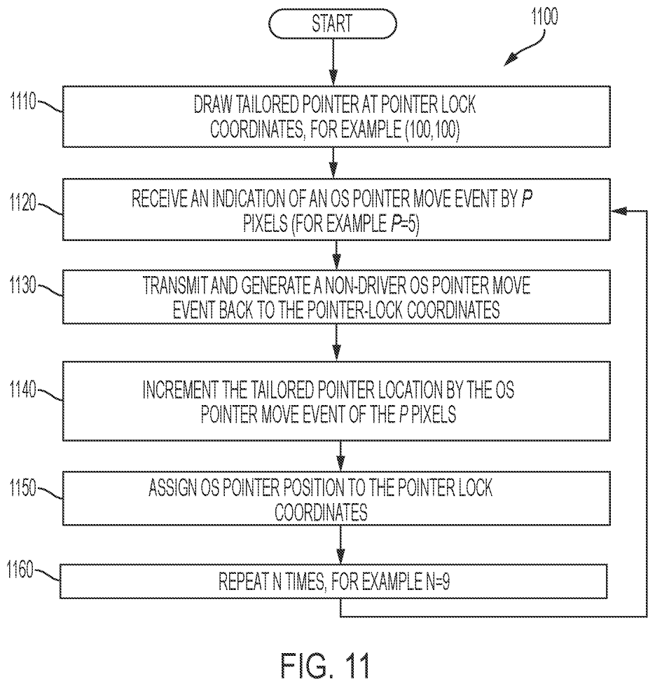

FIG. 11 is a flowchart of a method 1100 of an application of a tailored pointer, in which one or more pointer locks are used. Method 1100 can be applied to legitimate local users and malware users. Operations for each are considered in turn. The coordinate values, number of pixels moved, number of iterations, and other values herein are included for illustration purposes. These parameters would vary with different embodiments.

At the beginning of a web session for a legitimate local user, the OS pointer position may be known by the OS to be at screen position (100,100), which corresponds to the pointer lock coordinates at the center of the screen. In box 1110, method 1100 draws a tailored pointer at the pointer lock coordinates. This is the “current” tailored pointer position.

In box 1120, method 1100 receives an indication of an OS pointer move event by, for example P pixels, where P=5. As the legitimate local user moves the mouse, the local pointer driver causes the local OS to place the pointer at, for example (105, 100) due to the movement by five pixels.

In box 1130, method 1100 transmits and generates a non-driver OS pointer move event back to the pointer lock coordinates, in response to the news that the OS pointer has been shifted to (105,100).

In box 1140, method 1100 increments the tailored pointer location by five pixels corresponding to the received OS move event. To accomplish this, the browser reports a +(5,0) move to the renderer or drawing capability of the tailored pointer. In this example, the location of the tailored pointer location increases by 5 pixels with each iteration.

In box 1150, method 110 assigns the OS pointer position to the pointer lock coordinates of, for example, (100, 100).

In block 1160, method 1100 repeats steps 1120-1150 N times. For example, 9 times for a total of 10 iterations. For this example, the tailored pointer location incrementally and smoothly moves, 5 pixels at a time, from (100,100) to (150,100), with each iteration.

The method 1100 can also be applied for a remote malware user. The remote driver, such as a remote malware user. It is unlikely that the pointer of the remote driver starts at the pointer lock coordinates of (100,100). For example, the OS pointer at the remote driver's device may start at screen coordinates (300, 100). After the remove hacker establishes a connection to control the targeted machine, the remote hacker begins to drive or control the pointer of the targeted machine by sending its own coordinates as pointer movement commands. In box 1110, method 1100 draws a tailored pointer at pointer lock coordinates (100, 100). The remote hacker may then issue a command to move from its starting point of (300, 100) to (295, 100).

In box 1120, method 1100 receives a command to move the pointer to (295, 100). In box 1130, method 1100 generates a non-driver OS pointer move event back to the pointer lock coordinates of (100, 100).

In box 1140, method 1100 increments the tailored pointer location by (295, 100)−(100, 100)=(195, 0). This causes the tailored pointer location to “jump” by 195 pixels. Subsequent iterations will lead to jumps of 190, 185, etc. pixels.

In box 1150, method 1100 assigns the OS pointer position to the pointer lock coordinates, while the visible tailored pointer locations are “jumping” to multiple screen locations, making it difficult for the malware user to click on the OS pointer.

In some embodiments, the method 1100, under control of the local browser, may selectively accept or ignore pointer events fed to it from its OS.

In some embodiments, the method 1100 may, at random intervals and/or as a function of OS pointer position, and/or dependent on user actions, change the OS pointer position. Such changes would be known to the local browser or application, but not known to a remote user.

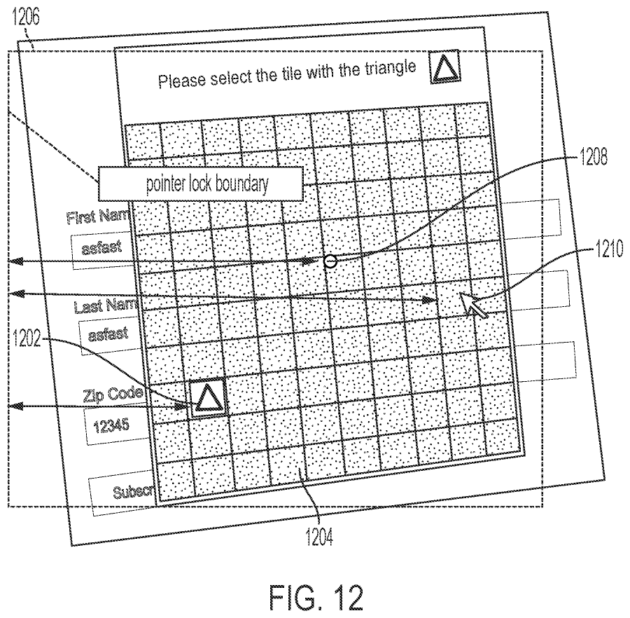

FIG. 12 shows another implementation of an application of a tailored pointer, in which one or more pointer locks 1208 are used for pointer 1210 positioning. Let the triangle image 1202 be placed on one of the 10×10 tiles in the grid 1204 shown. If the “fake” pointer image is placed on the “other side” (to the right in this image) of the hot spot from the triangle the user must “move” the “pointer-locked” hot spot into the pointer lock boundary 1206 area to hit the triangle target 1202.

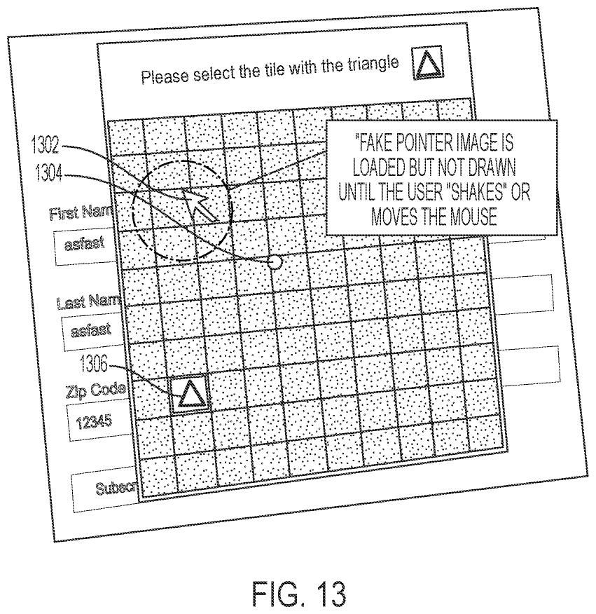

FIG. 13 shows another implementation of an application of a tailored pointer 1302, in which a pointer is not drawn until the pointer is in motion.

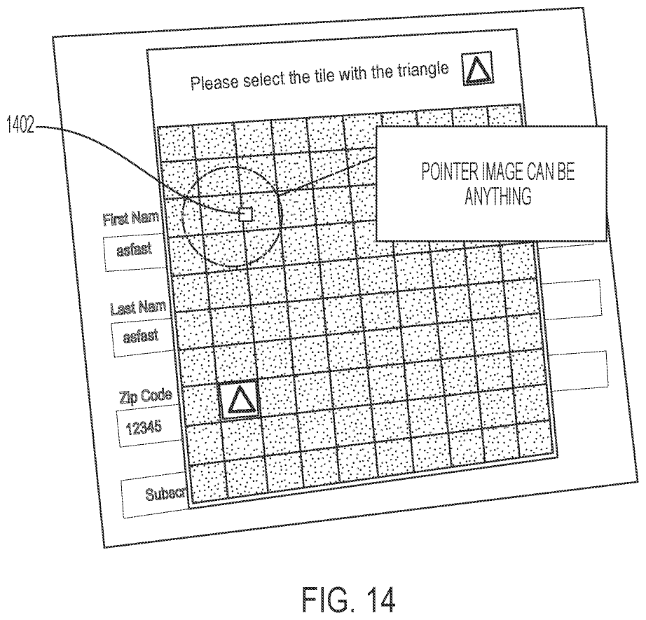

FIG. 14 shows another implementation of an application of a tailored pointer, in which the tailored pointer 1402 appears as something other than a classical “arrow” icon. In current practice any webpage is free to define a custom pointer image as a canvas, svg image, jpeg or any other format as specified to create an enjoyable or fun user experience—for example a web game might define the pointer to look like the cross hairs of a rifle scope. In another scenario the pointer might appear as a running/jumping cartoon-like human figure, etc.—the malware can readily locate the triangle but it has no provided context with which to locate the abstract pointer. As an example: classical captcha provides the “street signs” as a stated context and challenges the AI/algorithm to utilize that stated context to solve the challenge. In another example, the tailored pointer may appear as an icon, emoji, or cartoon character.

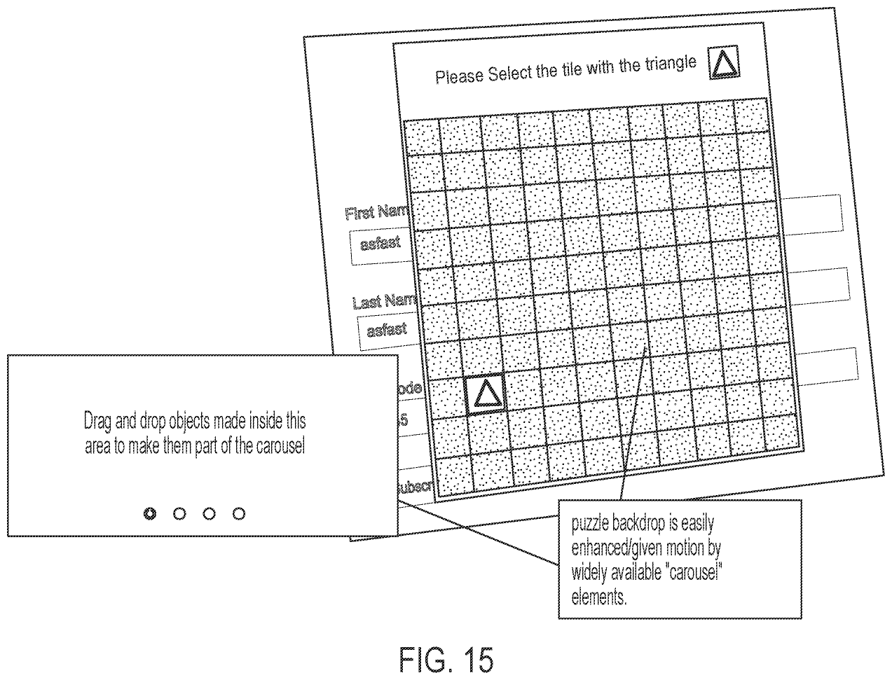

FIG. 15 illustrates another implementation of an application of a tailored pointer, in which the pointer is defined as the “thing” in motion.

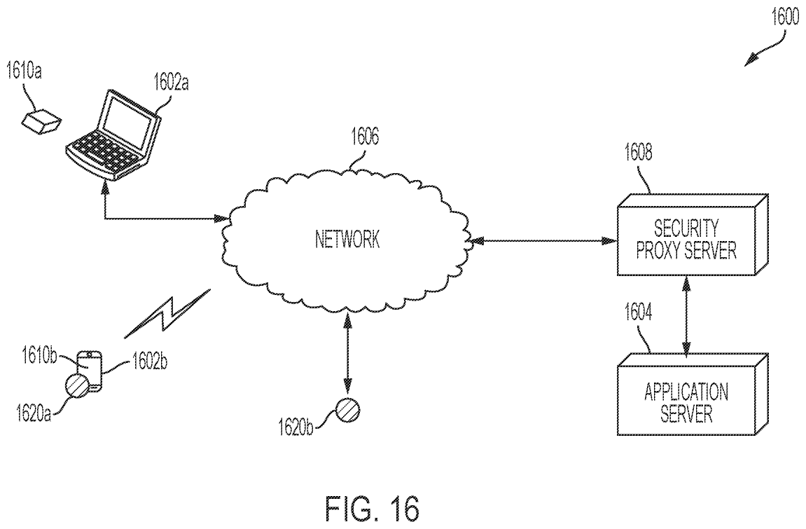

FIG. 16 illustrates a diagram of an example input device security environment 1600, according to an example embodiment of the present disclosure. In the illustrated example, client devices 1602 are communicatively coupled to an application server 1604 via a network 1606 and a proxy server 1608. The client devices 1602a and 1602b may include any smartphone, tablet computer, laptop computer, workstation, desktop computer, etc. The client devices 1602a and 1602b may include one or more input devices such as a mouse 1610a and/or a touchscreen 1610b.

The example application server 1604 is configured to provide or host any application, website, multimedia content, social media information, etc. The network 1606 may include any network such as the Internet or a local area network. In some embodiments, the application server 1604 may communicate with an application operating on the client device 1602. For example, the application server 1604 may host a website that is displayed within a web browser on the client device 1602. In other embodiments, the application server 1604 includes one or more application programming interfaces (“APIs”) connected to processors and the client devices 1602 include an application (e.g., an App) that is configured to communicate with the APIs.

The example security proxy server 1608 is configured to receive data transmitted from the application server 1604 to the client devices 1602. The data may include, for example, application code, such as website code or data transmitted to an application. As disclosed herein, the security proxy server 1608 is configured to modify, add, and/or remove soft information by changing the application code. For instance, the security proxy server 1608 may change a location of one or more application elements by hiding some application elements from display and creating graphics that visually imitate the elements for display at a location that is an offset vector away from the hidden elements. In other examples, the security proxy server 1608 is configured to change a selectable area or page coordinates related one or more functions that are associated with application elements.

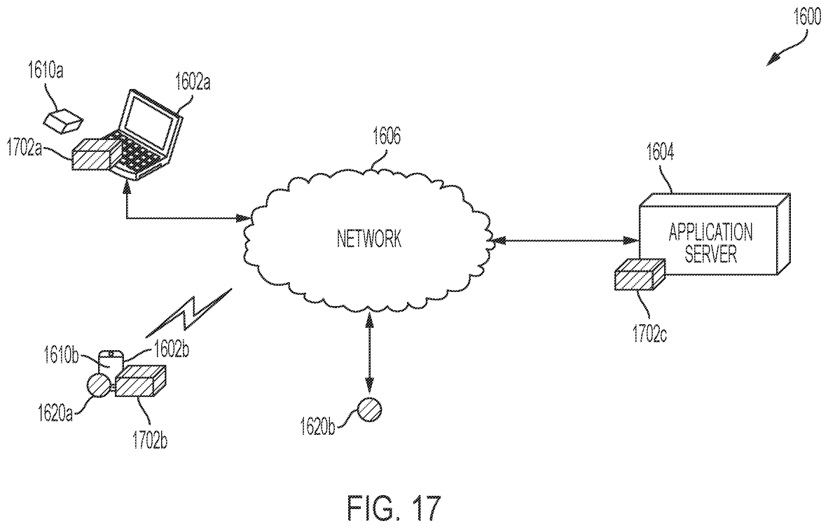

The security proxy server 1608 may be configured to modify any type of application code including, for example, TypeScript, eXtensible Markup Language (“XML”), HyperText Markup Language (“HTML”), JavaScript, Cascading Style Sheet (“CSS”), and/or other script-based language that is compatible with a web browser or other user interface-centric application. In some embodiments, the proxy server 1608 may cause a security application to be installed on the client device 1602, as shown in FIG. 17. The security application may include, for example, a browser plug-in, applet, or other program configured to perform the operations described herein.

The example security proxy server 1608 may also change a location of a pointer. In some embodiments, the security proxy server 1608 creates or modifies a pointer file associated with the application code (or modifies a definition of a pointer in the application code) such that a pointer is displayed an offset vector away from a location of a pointer specified by an operating system of the client device. The server 1608 may also modify or cause the operating system pointer to be hidden from view. Additionally or alternatively, the security proxy server 1608 may modify an operating system pointer file to change a location at which a pointer is displayed within a pixel area, as discussed in connection with FIGS. 1B and 3 above.

For touchscreen devices, the security proxy server 1608 may change an input file associated with the touchscreen such that user-provided inputs are shifted by a determined offset. In other examples, the security proxy server 1608 may apply a hidden or viewable pointer that is specified to be located an offset away from where a user engages a touchscreen. The security proxy server 1608 may apply a hot spot for the pointer such that selection by a user in one location on the application viewer causes the pointer to provide a hot spot selection at another part of the application viewer.

FIG. 16 also illustrates malware or malicious applications 1620. The malware 1620 may be embedded on the client device 1602b and/or connected to the network 1606. The malware 1620 may locally attempt to provide inputs to access data from the application server 1604. The malware 1620 may analyze network traffic to provide inputs to access data from the application server 1604. In some instances, the malware 1620b may send instructions to the malware 1620a on the client device 1602b providing automated or manual control to access data from the application server 1604.

As disclosed throughout, the example security proxy server 1608 is configured to apply offsets to displayed application elements and pointer elements to prevent the malware 1620 from being able to interact with an application or webpage. The malware 1620 attempts to use pointer coordinates, as determined by an operating system of the client device 1602 to move to a designated application element, such as a “Submit” button. However, the “Submit” button is separate from a submit function, which is located a specified offset away, potentially with a hidden “Submit” button or other application element. As a result of the offset, the malicious application 1620 is unable to direct the pointer to the function that provides functionality for the “Submit” button, and is prevented from maliciously accessing the application server 1604.

The security proxy server 1608 may also be configured to process responses from the client devices 1602. The security proxy server 1608 may analyze a response to determine if a pointer selection corresponds to a location of a function (e.g., a hidden application element), a security element, or the displayed application element. Selection of the function is indicative that the user is legitimate, which causes the security proxy server 1608 to validate the selection and pass the response information to the application server 1604. Selection of a security element or the displayed application element is indicative of malware and causes the security proxy server 1608 to block or prevent the response from being transmitted to the application server 1604. In some embodiments, the security proxy server 1608 may generate and transmit an alarm and/or an alert to the application server 1604 that is indicative of the malware. In response, the application server 1604 may block the client device 1602 and/or transmit a message notifying a user of the malware.

FIG. 17 shows an alternative embodiment where the application server 1604 is connected directly to the network 1606 and the proxy server 1608 is replaced with a security application 1702 that is installed on the client device 1602. The application 1702 may include a plug-in to a web browser, a stand-alone application, a proxy for the client device, etc. In the illustrated example, the security application 1702 is configured to modify application code after it is received in the client device 1602 from the application server 1604. The application 1702 may modify the code prior to display on an application or within a web browser. As discussed above, the application 1702 may modify soft information related to application elements. The application 1702 may also modify a visual appearance of an operating system pointer specified for an application as disclosed herein.

Similar to the security proxy server 1608 of FIG. 16, the security application also be configured to process responses from the client devices 1602. Before transmission across the network 1606, the security application 1702 may analyze a response to determine if a pointer selection corresponds to a location of a function (e.g., a hidden application element), a security element, or the displayed application element. Selection of the function is indicative that the user is legitimate, which causes the security application 1702 to validate the selection and transmit the response information to the application server 1604. Selection of a security element or the displayed application element is indicative of malware and causes the security application 1702 to block or prevent the response from being transmitted to the application server 1604. In some embodiments, the security application 1702 may generate and transmit an alarm and/or an alert to the application server 1604 that is indicative of the malware. In response, the application server 1604 (or the security application 1702) may block the client device 1602 and/or transmit a message notifying a user of the malware.

### Graphical Pointer and Displayed Elements Embodiment

In some example embodiments, the input device security environment 1600 of FIGS. 16 and 17 may additionally or alternatively be configured to interfere with automated bots or other malicious applications for one or more turing tests that are configured for use with a website, application, database, etc. As shown in FIG. 16, the security proxy server 1608 may be configured to add one or more challenges to a webpage, application, and/or database for a session between the application server 1604 and the client devices 1602. In other embodiments, as shown in FIG. 17, the client devices 1602 and/or the application server 1604 may include a security application 1702, shown as security applications 1702a, 1702b, and 1702c. The security application 1702 is configured to inject or otherwise provide one or more challenges or tests disclosed herein.

In the embodiments of FIGS. 16 and 17, the malicious application 1620 may include an automated bot that is local to the client devices 1602, a bot that remotely accesses the devices 1602, or a bot that remotely accesses the application server 1604. In an example, the malicious application 1620 may include one or more bots configured to access a website to purchase a large volume of popular products or services for resale to customers at a significantly higher price. In other examples, the bot may include a malicious application configured to conduct a distributed denial of service attack on a website or database.

The security proxy server 1608 (and/or the security application 1702) is configured to select one or more challenges for webpages, databases, applications, etc. The challenges are configured to verify a user is a human user rather than a bot or malicious application. The challenges are designed to be solved relatively easy (e.g., within one to twenty seconds) by a human user but be difficult for a computer or bot to understand and solve. For example, the challenges are designed such that it takes a computer or a bot as much as 30 minutes to a few hours to solve.

In an example, the security proxy server 1608 selects a challenge for display on the client device 1602. The challenge may be displayed within a webpage, a popup window, an application, etc. To provide the challenge, the security proxy server 1608 is configured to select at least one display element file, a pointer file, and/or a challenge message file. The challenge may be associated with an answer file that includes, for example, coordinates corresponding a correct selection or answer. The challenge may also be associated with a response time threshold and/or a click threshold.

As disclosed herein, a display element includes multimedia content that is viewable or otherwise playable on a webpage, application, database, etc. The display element may include one or more images, video, audio, etc. The display element is configured to have coordinates of selectable locations within, for example, an image. The coordinates may be dimensioned to correspond to a pixel size or configured to be more granular, such as a group of pixels or a size dimension. In some examples, a grid or matrix may be used instead of coordinates, where different rectangles (or other shapes) of the grid correspond to an identifier or coordinates that are returned to the security proxy server 1608 when selected by a pointer.

The display element includes one or more items shown within the multimedia content. The items may include people, animals, characters, scenery, vehicles, etc. There is virtually no limit to the types of items that may be provided within an image. In some examples, the images may be photographs or pictures that are created specifically for the challenge, where one or more items are included from other image files. The display element file may include, for example, a .jpeg image, a .tiff image, a gig image, a bmp image, etc.

In some embodiments, the display element may include or be specified by a multimedia file, a java file, or other plug-in that provides user-interaction within a webpage, application, or database. The display object may include instructions that cause at least part of the displayed items to change in response to pointer movement, such as a mouse-over or hover. For example, coordinates of a pointer position may be used to determine which portion of a display element are to be enlarged or made smaller (e.g., zoom out) or otherwise cause a portion of the displayed element to change in appearance. In an example, an animation may be displayed in response to a mouse-over. In another example, a portion of a first image within a display element may be made transparent or replaced by a second image in response to a mouse-over. For instance, a hover by a pointer may cause an arm of a person to change locations or appear to move. In another instance, a hover by a pointer may cause a portion of a displayed image to be made transparent to reveal a second image, as though the second image was hidden underneath. The instructions for the display element may be transmitted by the security proxy server 1608 for rendering by a web browser or application based on detected coordinates of a pointer position. In other instances, the security proxy server 1608 may receive pointer coordinates from the client device 1602 and accordingly transmit additional instructions and/or display elements to change an appearance of the displayed element.

As discussed herein, a pointer file defines how a pointer is to be displayed. The pointer file may, for example, include or reference an image file that is to replace an arrow image of a pointer with another graphical representation. As one can appreciate, the pointer file may reference virtually any shape, design, or graphical representation of a pointer. In some embodiments, the security proxy server 1608 may transmit one or more instructions for updating an OS pointer rather than sending a pointer file for a webpage or an application.

In some instances, a hot spot of a pointer may be moved to a center of a graphical representation of the pointer to provide better responsiveness from a user. Further, in some embodiments, the pointer hot spot may be provided at an offset from the display element, as discussed above, to counter bots or malicious applications that are attempting to control a pointer at a client device.

As disclosed herein, challenge text corresponds to one or more prompts that are provided to a user for answering a challenge. The challenge text may be included within a file and/or one or more messages transmitted from the security proxy server 1608. In other embodiments, the challenge text is included within the display element file.

The example security proxy server 1608 is configured to use one or more answer files associated with a challenge to determine if a user/bot provided a correct answer. The answer file may include one or more coordinates and/or grid locations representative of a pointer being moved to a specified location on a display element. In some embodiments, a user has to make a pointer selection, causing the selection coordinates to be transmitted to the server 1608 for comparison to the answer file. In other instances, the server 1608 may receive a stream of data that is indicative of pointer position and compare the stream to the answer file. The steam of point positions may also correspond to when a user makes a pointer selection by moving the pointer while holding down a left or right click button. These instances may correspond to challenges where a user is prompted to use the pointer to draw a shape/figure with the pointer over a display element. One or more of the coordinates from the stream of data is compared to one or more coordinates within the answer file to determine if the user drew the correct shape or moved the pointer in the specified manner.

In an example, a challenge could prompt a user to make a dancer in a display element do a dance called the floss. To answer the challenge correctly, a user has to select an arm of the dancer in the display element, which causes the arm (and also possibly the hips and legs) to become animated. The user then has to move in the arm in the correct manner corresponding to the ‘floss’ dance move. Coordinates of the pointer position are retuned to the server 1608 and compared to an answer file to determine if the user moved the pointer in the correct back-and-forth manner at least a certain number of times.

In some embodiments, a challenge may be associated with a time threshold and/or a click threshold. The thresholds may be stored in separate files and/or included within an answer file. The time threshold corresponds to an amount of time a user is given to answer a challenge. The time threshold may be 10 seconds, 30 seconds, 1 minute, 5 minutes, etc. The server 1608 may begin a timer when the proxy server 1608 transmits the challenge to the client device 1602. The server 1608 ends the timer when a response message is received from the client device 1608 including, for example, a pointer selection and corresponding pointer coordinates or grid identifiers (e.g., a location of a hot spot of a pointer when a user pressed a selection key on a mouse or similar input device) with respect to a display element. If a response is received before the threshold, the response is compared to an answer. If a response is provided after the threshold, the server 1608 may provide another challenge, transmit an error to the client device 1602, and/or transmit an alarm or alert to the application server 1604. In some embodiments, two thresholds may be configured. If a response is received between the two thresholds, a second challenge is generated. If a response is received after the second threshold, the proxy server 1608 may cause the session to end, such as by closing a browser or sending an instruction to the application server 1604 to end a session with a client device.

Additionally or alternatively, the security proxy server 1608 may use one or more click thresholds. The thresholds ensure that a bot cannot return a significant number of pointer selections within a short time period in an attempt to randomly select the correct location. For example, the server 1608 may be configured such that a first received pointer selection is used for comparison to an answer. Later received selections are configured to be disregarded. In other embodiments, the server 1608 may compare the first two, three, five or ten pointer selections for comparison to the answer file. In addition, the server 1608 may compare a time difference between the selections. The server 1608 may determine whether the pointer selections are received less than 0.25, 0.5, 1.0, or 2.0 seconds apart (e.g., a threshold time). The server 1608 generates an error indicative of a detection of a bot or malicious application if the selections are made within the time threshold. In addition, reception of a number of selections greater than a threshold may cause the server 1608 to generate an error message for the client device 1602 and/or the application server 1604.

In some embodiments, the challenges may be created manually by an operator. For example, an operator can select a display element, any feedback or animation features of the display element, coordinates or grid size, and/or pointer file information/graphical representation. The operator may then select one or more coordinates/pixels/grid locations that correspond to a correct answer. The operator may also select timer/click thresholds. The operator may also create text providing a prompt or challenge instruction to a user.

In other embodiments, the server 1608 is configured to automatically generate the challenges. For example, the server 1608 may have access to a library of images and/or videos. Further, the server 1608 may have access to images of items and/or graphical representations of pointers. The server 1608 selects an image, optionally adds one or more items from other images, and creates a coordinate space and/or grid for the display element. The server 1608 may also select a graphical representation for the pointer. In some embodiments, the server 1608 performs one or more image analysis routines, searches for metadata, and/or otherwise identifies content of an image. The server 1608 may also perform the image analysis or metadata analysis for selecting a graphical representation of a pointer. The graphical representations may include metadata or text that identifies the image and/or use of the image for selection in creating a challenge prompt.

The server 1608 uses the graphical representation of the pointer and/or the results of the image analysis/metadata analysis to create or determine a challenge prompt. For example, upon identifying a person in a picture, and selecting a soda can, the server 1608 may select or create a message that indicates a descriptor of the graphical representation should be placed on a body part of the person. The server 1608 may access, for example, a database that links different descriptors of items, display elements, and/or graphical representations of pointers to one or more phrases, actions, instructions, etc.

In some embodiments, the display element, items within a display element, and/or graphical representation of a pointer may be selected for marketing or commercial value. For example, a sponsor, such as a manufacturer of soda, may request that the graphical representation of the pointer include an image of the manufacturer's product. Additionally or alternatively, the items within a display element may include promotional material or promoted individuals. In an example, a challenge for purchasing concert tickets may show an image of a performer related to the performance. Such tie-ins increase a user's engagement with the challenge while making the challenge seem less burdensome, or even fun. Further, the use of commercialized products or individuals enables a website host to monetize the challenge.

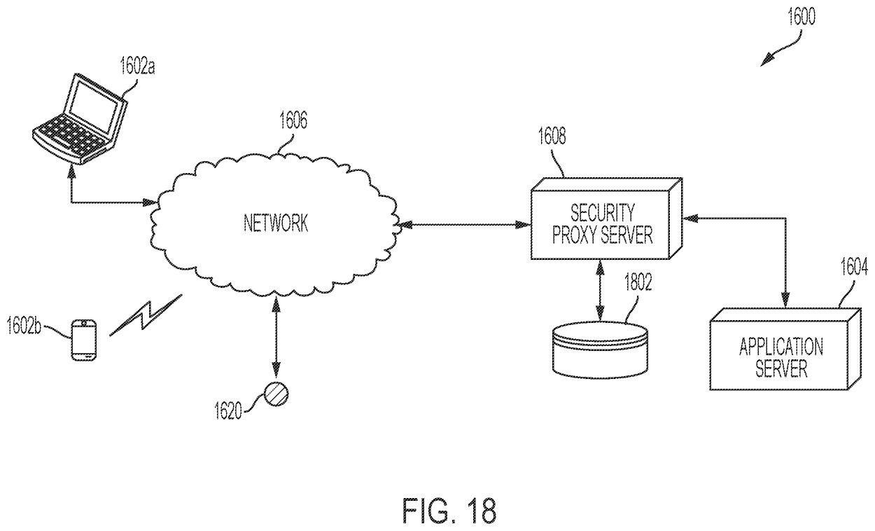

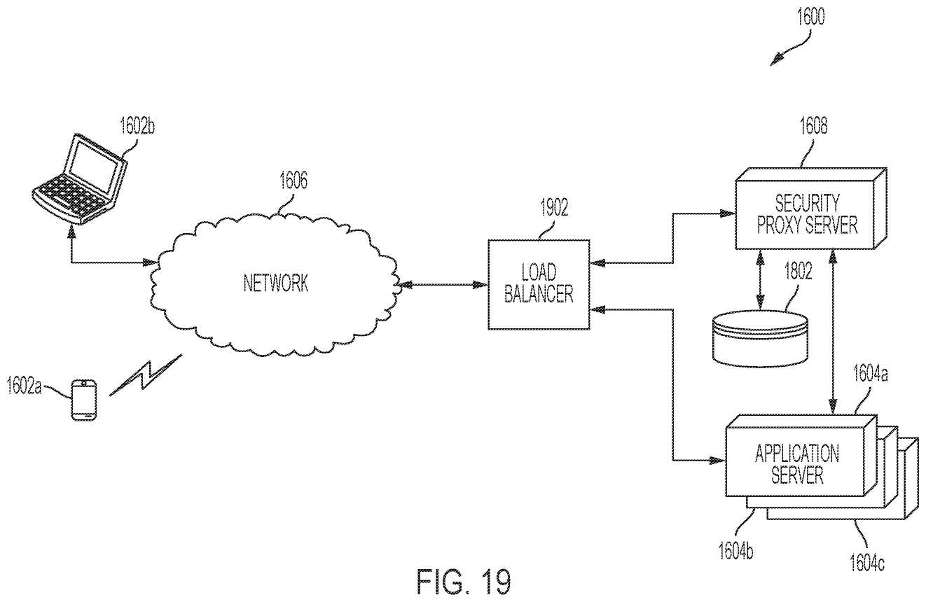

FIGS. 18 and 19 show additional examples of the example environment 1600 of FIGS. 16 and 17, according to example embodiments of the present disclosure. FIG. 18 shows an example where the security proxy server 1608 is provisioned between the application server 1604 and the network 1606. The client devices 1602 include web browsers or applications for interfacing with the application server 1604. In addition, the malicious application 1620 is configured to interface with the application server 1604. The security proxy server 1608 is configured to provide one or more challenges for portions of the website that include sensitive information or known to be typically abused by bots. As such, the security proxy server 1608 only permits human users to access critical content from the application server 1604.

In some embodiments, the security proxy server 1608 is communicatively coupled to a database 1802 (e.g., a memory device). The example database 1802 is configured to store a plurality of challenges (e.g., challenge files). Each of the challenges may specify a display element (or an identifier or link to a display element), a user prompt, pointer information, and a location of the display element that corresponds to a correct response. The security proxy server 1608 is configured to identify one or more webpages or application calls that are designated as being critical where a challenge is desired. The server 1608 accordingly injects or otherwise adds at least some information from a selected challenge file to the webpage or application for transmission to the client devices 1602.

FIG. 19 shows an example of the environment 1600 in which a load balancer 1902 is provisioned between the servers 1604 and 1608 and the network 1606. The load balancer 1902 is configured to provide electronic load balancing to point incoming requests from the client devices 1602 to internal recourses that are provided by one or more application servers 1604. The load balancer 1902 is also configured to transmit responses from the servers 1604 to the appropriate endpoint at the client devices 1602. In some instances, the load balancer 1902 may include a HTTP/HTTPS listener, one or more gateways, and/or one or more APIs.

In the illustrated example, the security proxy server 1608 is configured to provide security for only a portion of the webpages or application features that are hosted or made available by the application server 1604. For the remainder of the webpages or application content, transmissions bypass the server 1608 and are routed by the load balancer 1902 directly to the application server 1604. The load balancer 1902 may be configured to determine whether a request from the client device 1602 is to be routed to the server 1608 by, for example, comparing the request to a data structure that identifies (e.g., rules that define criteria for message routing) which request types are to be forwarded to the server 1608. The application server 1604 may be configured to route certain responses to the server 1608 instead of the client device 1602 based on response type. For example, responses that include a webpage with a challenge (e.g., transmission of a key session resource) may be routed to the security server 1608. The key session resource may include, for example, authentication pages, adding-to-cart pages, purchase pages, completion pages, etc., which are favorite targets for client-side fraud and abuse by bots. In some examples, the server 1608 is configured to operate with the load balancer 1902 at network layers 4 to 7 of the OSI model. It should be appreciated that two load balancers may be used instead of one. A first load balancer may be provisioned to handle incoming traffic from client devices. A second load balancer may be configured to handle outbound traffic from the application server 1604.

In some embodiments, the server 1608 may be provisioned as an auto-scaling group to take advantage of cloud computing reliability and handle dynamic increases at load, such as when concert tickets go on sale.

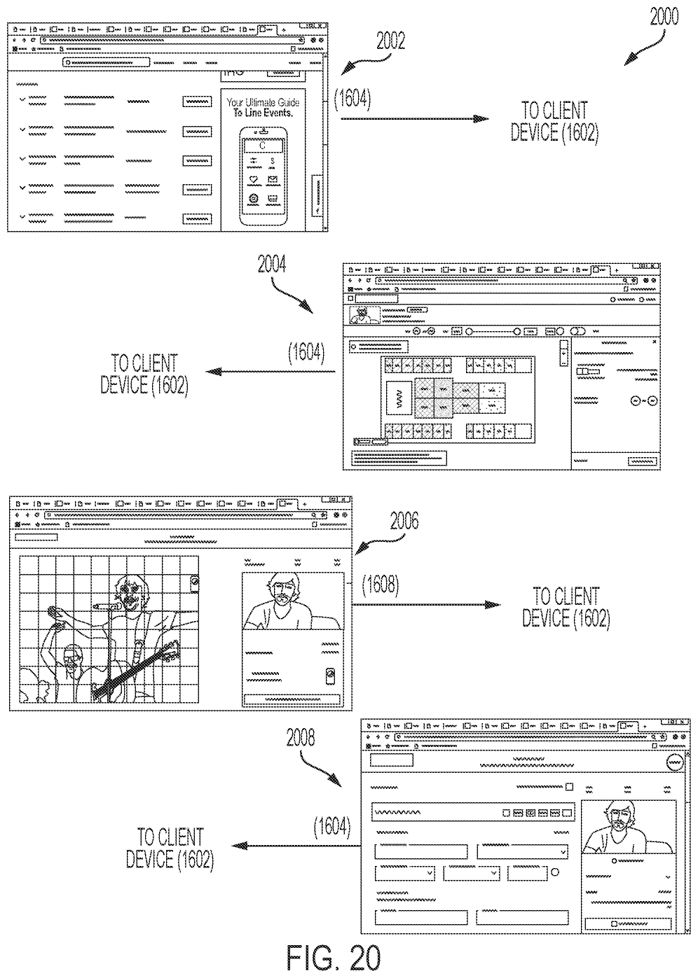

FIG. 20 shows a diagram illustrative of a procedure 2000 that is performed by the servers 1604 and 1608 of FIGS. 16 to 19 for transmitting content to a client device 1602, where the content relates to at least one challenge, according to an example embodiment of the present disclosure. First, a client device 1602 connects to a webpage, database, or API interface hosted by the application server 1604 via a connection request message. In response to the message, the server 1604 begins a new session and transmits a landing page 2002 to the client device 1602. The transmission includes HTTP code that is provided in one or more messages that enable a web browser at the client device 1602 to display the landing page 2002. The landing page 2002 may include a webpage, a database, or a home interface of an application.

In the illustrated example, a user of the client device 1602 navigates the landing page 2002 to select tickets to a concert. The client device 1602 transmits one or more messages including a request for a webpage for selecting tickets. In response to the message, the application server 1604 is configured to transmit a ticket selection webpage 2004 that enables a user to select seats in a venue for a concert on a particular day/time.

A user of the client device 1602 selects a seat location and clicks a button on the page 2004 to submit the request, causing the client device 1602 to send one or more messages indicative of the selection. The application server 1604 next determines that a challenge is to be presented to confirm the user is human. In some embodiments, the server 1604 sends a request message (or an indication message) to the security proxy server 1608 to transmit webpage 2006 with the challenge. In other embodiments, the application server 1604 transmits a webpage with a generic challenge to the proxy server 1608. In response, the proxy server 1608 replaces the generic challenge with information from one of the challenges disclosed herein. The proxy server 1608 then transmits the webpage 2006 to the client device 1602 with the appropriate challenge. In some embodiments, the server 1604 transmits the webpage with a generic challenge. However, a load balancer may determine the webpage includes the generic challenge and forwards the transmission to the proxy server 1608. In response, the proxy server 1608 replaces the generic challenge with information from a selected challenge and transmits the webpage 1608 to the client device 1602. In addition to the webpage 1608, the server 1608 may also transmit a pointer file and/or instructions for changing properties of the pointer.

The client device 1602 renders the webpage 2006 and receives pointer movement and selection information from the user. The client device 1602 transmits the pointer movement and selection information in one or more response messages. In some instances, the client device 1602 may also transmit an identifier or code related to the challenge. The security proxy server 1608 receives the information, which is compared to an answer file that corresponds to the selected challenge. In some embodiments, a load balancer 1902 routes the information to the server 1608 after determining a response or information related to the page 2006 is intended for the security server 1608. In other embodiments, response messages from the client device 1602 may be addressed to the server 1608. The server 1608 compares the information from the pointer to an answer file and/or one or more time/click thresholds. If the thresholds are satisfied and/or the answer is correct, the server 1608 is configured to transmit a positive (or correct) response message to the generic challenge to the application server 1604, which causes the application server 1604 to transmit a payment information page 2008 (e.g., a second webpage) to the client device 1602 to complete the payment. If at least one of the thresholds are not met or the answer is incorrect, the server 1608 transmits a negative (or incorrect) response message to the server 1604. The negative response message may be transmitted to the client device 1602 and include information from another challenge that is also related to the previously replaced generic challenge. This other challenge provides the client device 1602 another opportunity to provide a correct answer. Additionally or alternatively, in response to a negative response message from the proxy server 1608, the server 1604 may transmit another generic challenge, repeating the steps discussed in connection with webpage 2006. Alternatively, the server 1604 may terminate the session with the client device 1602 and/or cause the client device 1602 to be blocked from accessing the server 1604. This may include transmitting a MAC or IP address of the client device 1602 to the load balancer 1902 or a gateway for inclusion on a block list or data structure.

In the illustrated example, the application server 1604 and the client device 1602 are not modified. Instead, the proxy server 1608 inserts the challenge into the workflow such that its insertion is not detected by the application server 1604, or causes the application server 1604 to be updated. Further, the server 1608 is only accessed for the challenge, thereby limiting the bandwidth used by the system.

In some embodiments, the proxy server 1608 may be replaced by the security application 1702 on the client device 1602. In these embodiments, the security application 1702 detects the generic challenge within the app or website traffic, and replaces the generic challenge with a robust challenge. Based on a comparison to an answer file, the security application 1702 provides a response to the application server 1604 for the generic challenge that is positive or negative.

In some embodiments, the proxy server 1608 is not needed. Instead, the application server 1604, using the security application 1702c, selects a robust challenge as part of the webpage 2006.

In the illustrated example of FIG. 20, the security proxy server 1608 is configured to replace a generic challenge with a robust challenge, described herein. In some instances, the challenge and/or the graphical representation of the pointer are selected based on a context of the purchase. As such, a generic challenge may include metadata or indicators used by the server 1608 for selection of a challenge file, a display element, items for a display element, and/or a graphical representation of a pointer. For example, the generic challenge may identify a musician's name and a beverage company. In response, the server 1608 selects a display element and/or items that correspond to the musician's name. In addition, the server 1608 selects a graphical representation of a pointer based on the name of the beverage company. Further, a challenge prompt may be selected based on the selected display element/items and/or the graphical representation of the pointer.

In some embodiments, the security proxy server 1608 may provide an invisible first test using the methods and system described above in connection with FIGS. 1 to 17. The invisible test may include providing a pointer at an offset from a hot spot and providing an offset between displayed page elements and hidden page elements that are selectable. If the first test returns a correct answer, a second challenge is not provided. However, if the second test returns an incorrect answer, the server 1608 and/or the application server 1604 is configured to display the webpage 2006 with the visible second test. In other examples, the invisible test may be combined with the visible test in a single webpage or application. For example, a display element may be offset from selectable grids or coordinates that correspond to an offset of a pointer from a hot spot.

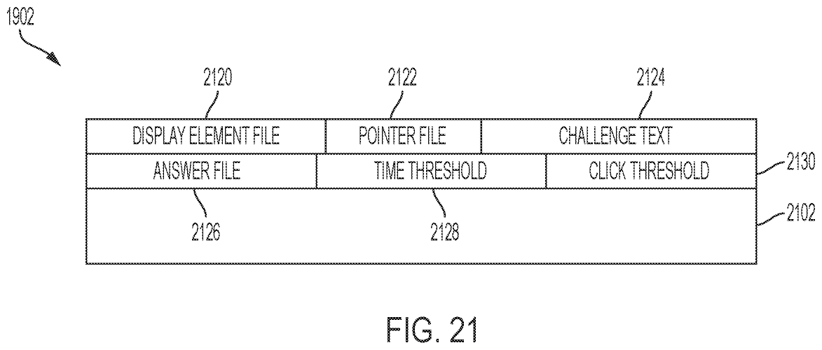

FIG. 21 shows a diagram that is illustrative of the database 1902, which is configured to store challenges, according to an example embodiment of the present disclosure. The database 1902 includes, for example, a challenge data structure 2102 (e.g., a challenge file) for each challenge selected and/or created. A challenge data structure 2102 may be created for each user that receives a challenge and/or a challenge data structure 2102 may be created to store a challenge for inclusion in a webpage or application.

The data structure 2102 may include one or more files or a single file. If the structure 2102 includes more than one file, the files may be organized by a folder or index. In some embodiments, the data structure 2102 may include links to files stored at other locations in the database 1902.

The data structure 2102 includes a display element file or partition 2120, a pointer file or partition 2122, challenge text 2124, an answer file or partition 2126, a time threshold 2128, and a click threshold 2130. The display element file or partition 2120 includes an image and/or one or more items for display of a challenge. Alternatively, the display element file or partition 2120 may include an identifier of a display element or a file link or hyperlink to a display element. The file or partition 2120 may be coded in a format for inclusion within webpage code. The file or partition 2120 may include active elements for pointer interaction and/or a coordinate/grid. The pointer file or partition 2122 includes parameters for displaying a pointer. The parameters may include a link to a graphical representation, a hot spot location, and/or movement/visual characteristics of a pointer. In some embodiments, the pointer file or partition 2122 may be replaced by pointer instructions for updating an OS pointer.

The data structure 2102 also includes challenge text that is displayable to provide instructions or prompts to a user. In some instances, the challenge text may be stored to the display element file or partition 2120. The data structure 2102 may also include an answer file or partition 2126. The example answer file or partition 2126 is configured to store one or more coordinates or grid identifiers that are indicative of a successful selection or response from a user. The coordinates and/or grid may be specified as to whether they are compared to pointer selections and/or pointer movement information. The answer file or partition 2126 may also contain one or more coordinates or grid identifiers that are indicative of an unsuccessful selection or response from a user. In some embodiments, the answer file or partition 2126 may include messages or actions to be performed based on whether a user's response is deemed correct or incorrect.

The time threshold 2128 includes one or more time limits for receiving a response from a user. The click threshold 2130 specifies one or more click limits before a response from a user is discarded. For example, a threshold of three indicates that the first three responses from a user are to be compared to the answer file or partition 2126 where the fourth and later responses are disregarded. In some instances, the click threshold 2130 may specify a maximum number of responses that can be received within a time period. Responses that exceed the maximum may be indicative of a bot, and accordingly discarded or deemed a failure of the challenge. While the thresholds 2128 and 2130 are shown as separate fields or partitions in the data structure 2102, in other embodiments they may be included within the answer file or partition 2126.

It should be appreciated that the answer file or partition 2126 or the data structure 2102 may include a link or reference to another challenge. In other embodiments, the data structure 2102 may include multiple challenges that have to be solved by a user. In some instances, the challenges are sequential such that a second challenge cannot be provided until the first challenge is successfully solved.

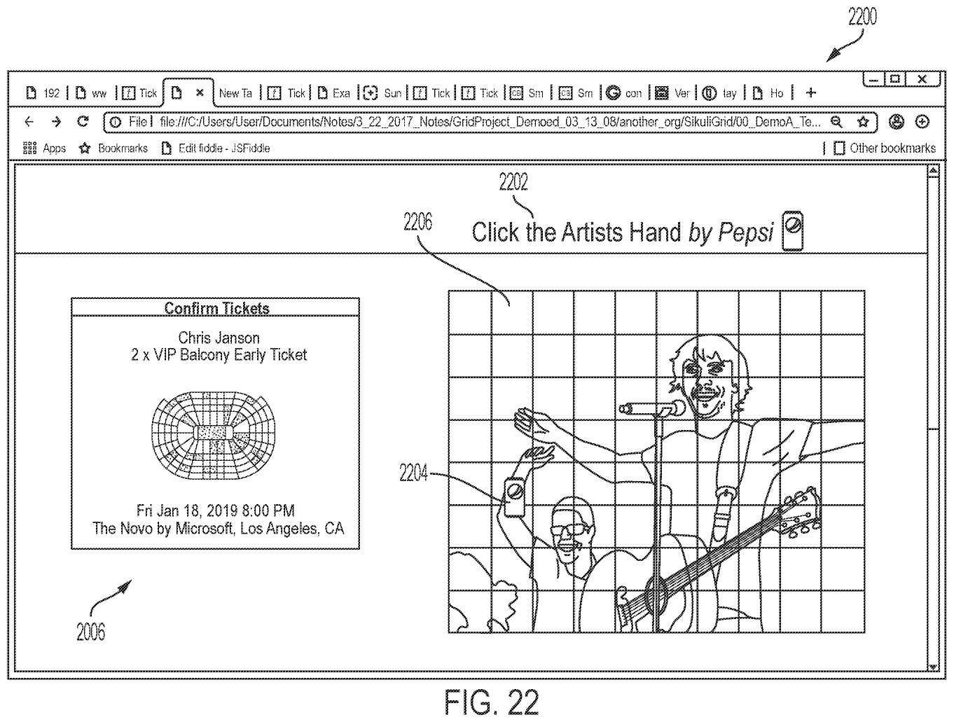

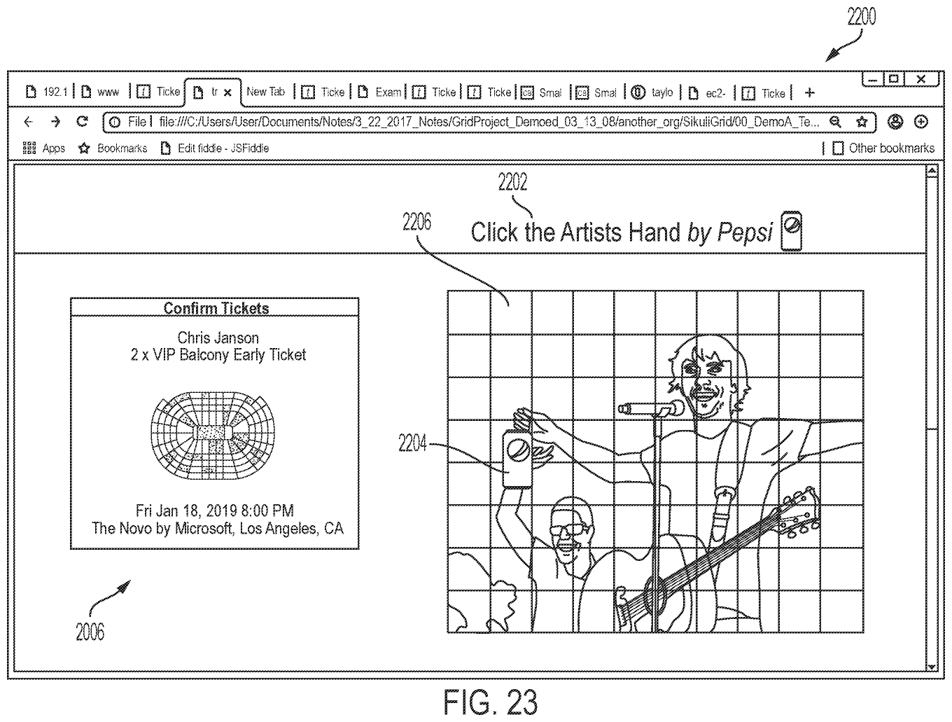

FIGS. 22 and 23 show diagrams of a user interface 2200 showing a webpage 2006 with challenge information, according to example embodiments of the present disclosure. The webpage 2006 may be displayed within a web browser (or app) of a client device 1602. Further, the webpage 2006 may be hosted or otherwise provided by the application server 1604. The webpage 2006 includes challenge information including a display element 2206, which includes an image of two musicians, a microphone, and a guitar (e.g., items). Challenge information shown in the webpage 2006 also includes a pointer 2204, which is stylized as a graphical representation of a soda can. The webpage 2006 further includes a challenge prompt 2202, which includes instructions for a user to solve the challenge.

In the illustrated embodiment, the display element 2206 is shown including a grid or matrix. In other examples, the grid lines may be omitted. In addition, the pointer 2204 may only be stylized when hovering over the display element 2206. The pointer 2204 may be displayed as a standard pointer arrow when moved off of the display element 2206. To solve the challenge, a user has to move the pointer to the musician's hand. A human user is able to quickly identify the musician's hand and move the pointer 2204 accordingly. In contrast, a bot would have to perform image analysis to identify the hands in the image, and then select the appropriate hand.

In some embodiments, movement of the pointer 2204 causes the pointer's location to be transmitted to the server 1608. A correct answer may be determined when the pointer 2204 is moved to one or more target grids that include the hand. In some instances, a user may have to make a pointer selection when hovering over the desired grid such that a grid or coordinates of the pointer selection are used by the server 1608 for comparison to the answer. FIG. 23 shows an illustration of the pointer 2204 moved to a location that corresponds to a correct answer to solve the challenge.

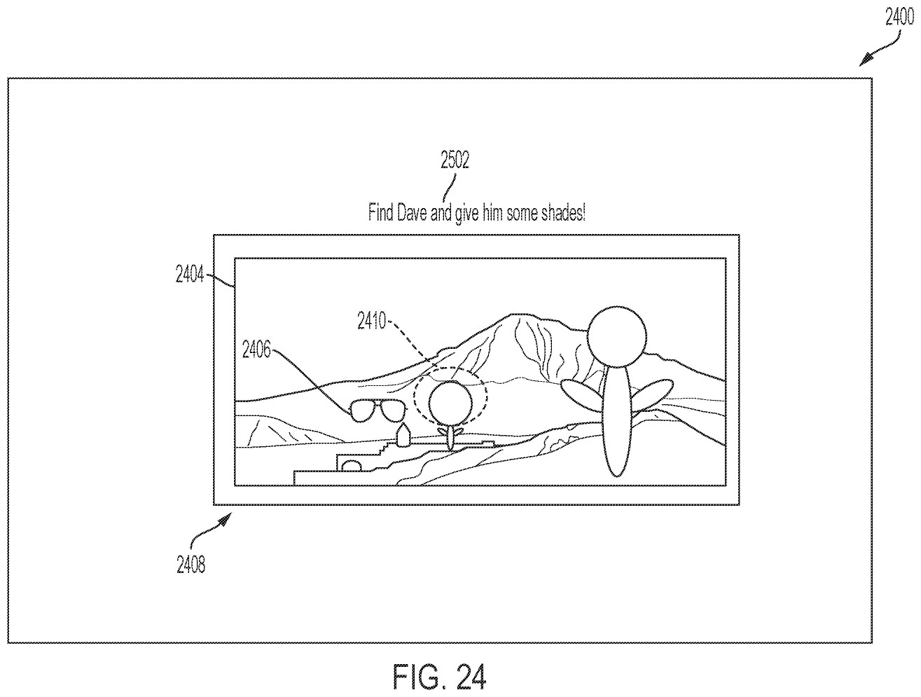

FIGS. 24 to 26 show additional embodiments of challenge information displayed in user interfaces. In FIG. 24, a user interface 2400 is provided within, for example, a web browser on a client device 1602. In the illustrated example, a challenge prompt 2402 (for a webpage 2408) includes text prompting a user to find a well-known person named ‘Dave’ who is shown in a display element 2404 (e.g., an image) and give him some shades (e.g., sunglasses). The display element 2404 includes an image of a mountain in the background and two individuals in the foreground (e.g., items). A stylized pointer 2406 is provided as a pair of sunglasses. In this example, hovering the pointer 2406 over the display element 2404 causes a portion 2410 of the display element to zoom in on the picture to help find ‘Dave’. The zoom of a localized potion of the display element 2406 enables a human user to more easily place the pair of sunglasses on Dave's face. In contrast, a computer would have to determine what is meant by the phrase “give him some shades” using one or more natural language algorithms, then identify Dave, then determine where the shades are to be placed. As a user moves the pointer 2406 over the display element 2404, coding of the display element causes a corresponding portion to zoom-in to track the user's movement, and a previous zoomed-in portion to be returned to a normal view.

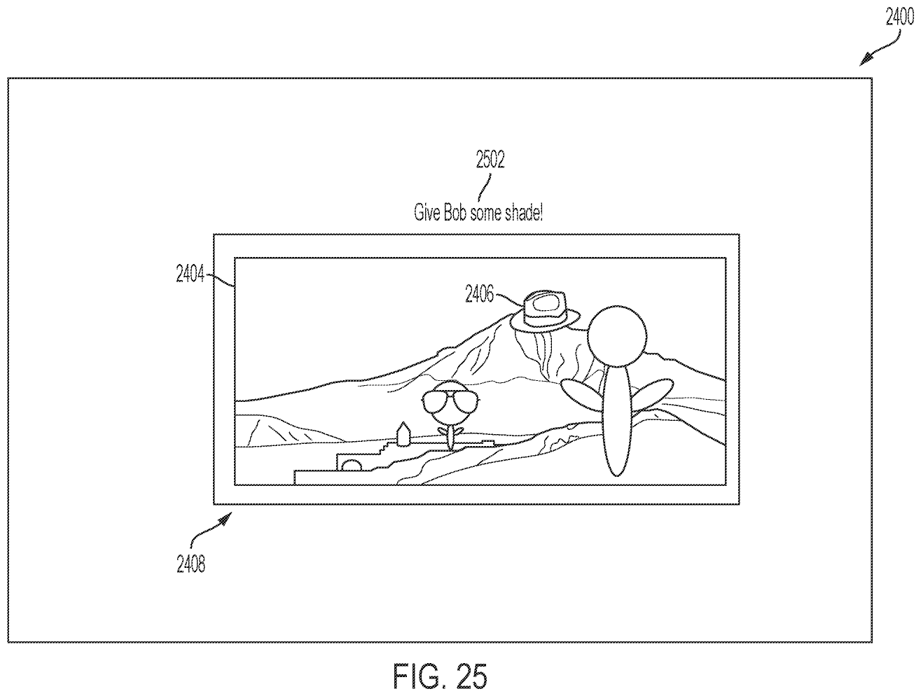

FIG. 25 shows a diagram of the display element 2404 with a first challenge solved where Dave now has shades. A second challenge is displayed after the server 1608 provides an indication that the first challenge is solved. In some instances, the webpage may include the answer for the first challenge as a function for launching the second challenge, where only the answer from the second challenge is transmitted back to the server 1608. The second challenge 2502 prompts a user to give Bob some shade, with the pointer 2406 now shown as a hat. A user is quickly able to understand that the hat is to be placed on Bob's head. Accordingly, the user moves the pointer 2406 to a top of the item of Bob shown in the display element 2404 to provide a correct answer. In contrast, a computer would have to determine what is meant by “give some shade”, then identify Bob, then identify Bob's head to properly move the pointer 2406.

In some embodiments, the web browser or application on the client device 1602 may transmit coordinates or grid values as the pointer 2406 is moved. The coordinates or grid values may be transmitted to the security proxy server 1608 and/or the application server 1604. If received, the proxy server 1608 compares the pointer movement to one or more movement patterns or sets of allowed coordinate positions. Some movement patterns may be straight, smooth line patterns or computationally random patterns that are indicative of bots moving a pointer. Other movement patterns have curvatures and/or high frequency jitter that is indicative of a human moving a pointer. The proxy server 1608 provides a negative response value if the pointer movement corresponds to a bot, thereby ending the challenge. If the pointer movement corresponds to human movement, the proxy server 1608 permits the user to complete the challenge or processes a challenge response message from the client device 1602. The proxy server 1608 may make similar determinations if the pointer movement exceeds an allowable range for completing the challenge.

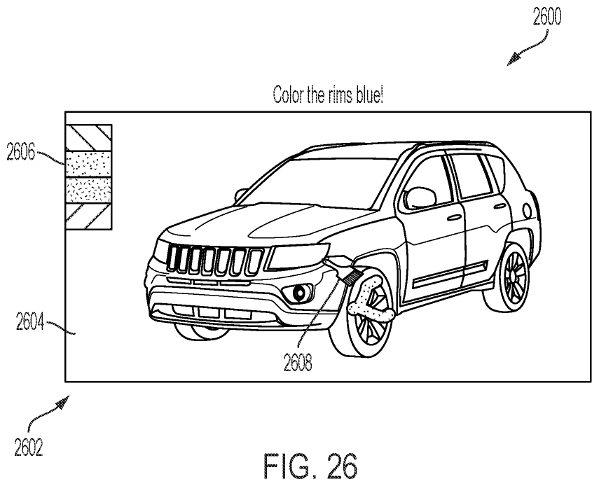

FIG. 26 shows a diagram of another challenge displayed within a webpage 2602 on a user interface 2600 of a client device 1602. The challenge prompts a user to paint the wheels of the vehicle blue. A display element 2604 includes an image of a car (e.g., an item) and rectangles 2606 with different colors. The challenge is a 2-step challenge. First, the user has to identify the correct color rectangle to pick-up the color for the brush-shaped pointer 2608. The user then has to identify the wheels on the vehicle and move the pointer 2608 over the wheels with a mouse button pressed to provide a painting function. The webpage 2602 may return coordinates and/or grid values corresponding to selections made by the pointer 2608. The server 1608 may first identify the correct location for the color rectangle, then compare one or more coordinates corresponding to the painting motion. In other examples, the server 1608 may only receive the coordinates corresponding to the painting motion, where the webpage 2602 may include code (or a webpage embedded function) that prevents the coordinates from being transmitted, or prevents a user from being able to paint if the correct paint color is not selected.

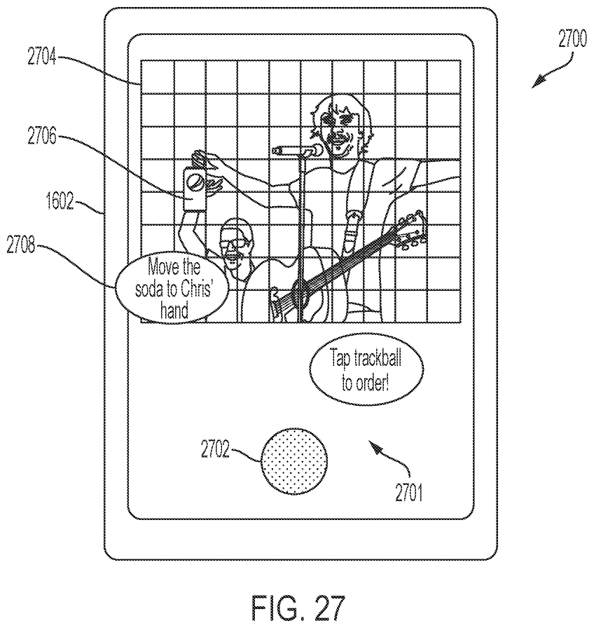

FIG. 27 shows an embodiment where a challenge is provided in an application 2700 (e.g., a plug-in or other software program) on a client device 1602, according to an example embodiment of the present disclosure. In the illustrated example, the application 2700 may be configured to provide the challenge. In other embodiments, the challenge may be provided by the security proxy server 1608 and/or the application server 1604. In yet other embodiments, the challenge may be provided by a security application 1702 operating on the client device 1602.

In the illustrated example, a user interface 2701 of the application 2700 displays a challenge to, for example, enable a user to purchase tickets for a concert. The challenge includes a display element 2704, which comprises two musician items, a microphone item, and a guitar item. The challenge also includes a stylized pointer 2706, which may be specified by a pointer file associated with the application 2700. The challenge also includes a user interface element 2702 that enables a user to control movement of the pointer 2706. The user interface element 2702 provides a control feature to compensate for the lack of a mouse or other hardware pointer control on smartphones, tablets, etc. In the illustrated example, a user moves their finger over the interface element 2702 to cause the pointer 2706 to move in the corresponding direction.

In other embodiments, the interface element 2702 may be used for controlling a scrolling, panning, and/or zooming of the display element 2704. In these embodiments, the pointer 2706 may be in a fixed location, and user's touch gestures via the interface element 2702 are used to rotate or move the display element 2704 for solving the challenge. In such an example, the display element 2704 may be larger than a display area of the client device 1602 to enable scrolling over, for example, large pictorial regions or maps.

Alternatively, the interface element 2702 may be used for cycling through sequential images that are shown as the display element 2704. The interface element 2702 may also be used to provide video control, such as fast forward, rewind, play, pause, etc. A challenge prompt may ask a user to scroll is a certain location in a video using the interface element 2702 as part of the solution.

The example challenge also includes a prompt 2708. In the illustrated example, the prompt is displayed adjacent to the pointer 2706 and is configured to track the movement of pointer 2706. In other examples, the prompt 2708 may be displayed outside of the display element 2704. Further, in some examples, the prompt 2708 may initially be hidden. After a certain amount of time and/or movement indicative that a user is unsure what to do with the pointer 2706, the prompt 2708 may be displayed to provide instructions. Such a feature may deter a bot that searches for text to determine how a pointer is to be moved. The bot, for example, may not move the pointer 2706 until a solution is determined. However, the prompt 2708 may not be displayed until the pointer 2706 is moved at least a certain number of boxes or coordinates of a grid. As a result, the bot may become stuck and fail to solve the challenge.

In some embodiments, the movement of a user's figure over the user interface element 2702 may be monitored instead of and/or in conjunction with movement of the pointer 2706. In the example, the application 2700 may operate with an operating system of the client device 1602 to determine screen coordinates corresponding to a location of a user's finger relative to the user interface element 2702. The change in coordinates (including relative swipes in one or more directions) can be analyzed or inferred as pointer movement. In addition, taps of the touchscreen by a user over the user interface element 2702 may be inferred as a pointer selection. In these embodiments, the change in coordinates and/or inferred pointer movement may be transmitted in a response message for comparison to a correct answer.

In some instances, the application 2700 may be configured to take advantage of a delta between the operating system of the client device 1602 and the application layer that provides the user interface element 2702 and/or the stylized pointer 2706. In an example, a user touches the user interface element 2702 or the stylized pointer 2606 to cause the pointer to move. As the user slides their finger, the application 2700 can provide a delay or advance the motion of the pointer 2706 relative to the hardware operating system touch event. However, the pointer movement on the screen is consistent with user's movement. The creation of this positional delta (discussed above in connection with FIGS. 1 to 15) may be stored in a response message and/or used for detecting a bot or provide interference with a bot attempting to solve the challenge.

It should be appreciated that in some embodiments, the user interface element 2702 shown in FIG. 27 may be replaced with other features for detecting pointer movement on a mobile device. For example, the application 2700 may display the stylized pointer 2706 and enable a user to move the pointer with their figure or stylus, which is detected by a touchscreen of the client device 1602. An operating system of the device 1602 provides coordinates of the touch gesture(s) and/or taps, which are used for providing pointer movement and/or pointer selections, as discussed herein.

In other instances, the application 2700 may use data from gyroscope(s) and/or accelerometers of the client device 1602. Physical movement of the client device 1602 (e.g., roll, pitch, yaw) may be used for controlling movement of the stylized pointer 2706. Additionally or alternatively, physical movement of the client device 1602 may be used for controlling a movement of the display element 2704, such as rotating or scrolling through portions of the display element.

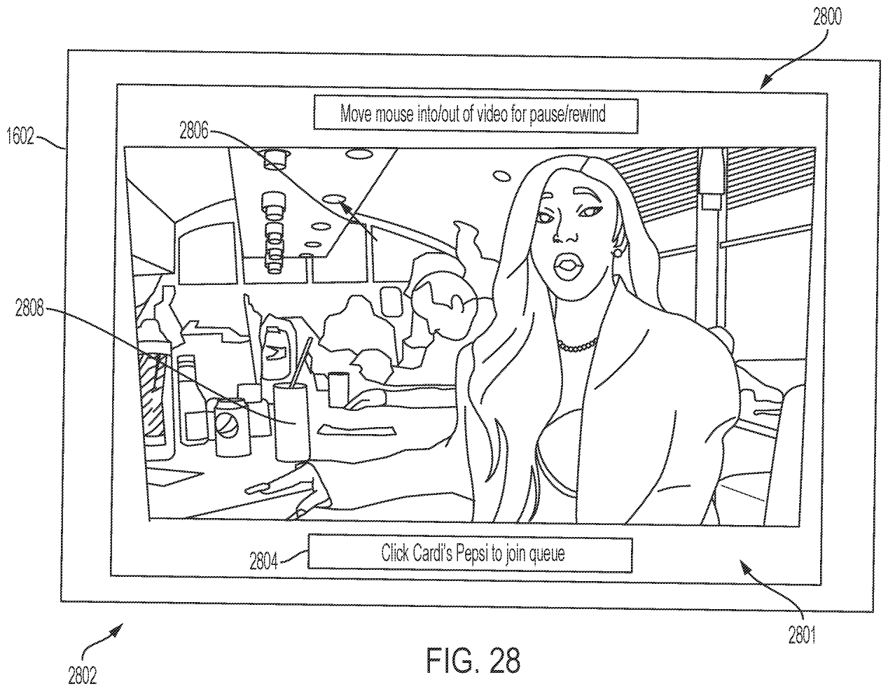

FIG. 28 shows an embodiment where a challenge is provided in an application 2800 (e.g., a video player) on a client device 1602, according to an example embodiment of the present disclosure. In the illustrated example, the application 2800 is configured to play a video, such as an advertisement, a movie trailer, a .gif video, etc. In other embodiments, the challenge may be provided by the security proxy server 1608 and/or the application server 1604. In yet other embodiments, the challenge may be provided by a security application 1702 operating on the client device 1602.

In the illustrated example, a user interface 2801 of the application 2800 displays a challenge to, for example, enable a user to purchase tickets to a concert. The challenge is conveyed via, for example, a graphical message 2804. The application 2800 causes the video to play. When the user sees an object in the video that is specified by the challenge, the use moves their pointer 2806 into a view area of the application 2800. In the illustrated example, the application 2800 (and/or the security proxy server 1608 and/or the application server 1604) cause at least some of the video play functionality, such as pause, play, fast forward, rewind, etc. to be tied to pointer movement. Thus, movement of the pointer 2806 into the video playback screen causes the application 2800 to pause the video.

The application 2800 (and/or the security proxy server 1608 and/or the application server 1604) apply the challenge to pixel locations of the video that correspond to a location of an object 2808, such as a glass. A routine or data structure may define the pixels for each video frame to compensate for movement of the object between frames. Selection of the object 2808 by the pointer 2806 provides a correct solution to the challenge, thereby enabling the application 2800 (and/or the security proxy server 1608 and/or the application server 1604) to display a subsequent screen for purchase of an item or service.

In the illustrated example, the video may include the display element, with correct answer coordinates defined for at least some of the frames. In other embodiments, the display element is provided as a transparent image over the video, with the correct answer coordinates defined for at least some of the frames. Selection of a coordinate by the pointer 2806 may cause the application 2800 to transmit a response message with the video frame number or identifier in addition to the coordinate values. Alternatively, the application 2800 may compare the coordinate and video frame identifier to internally stored correct answer coordinates for the displayed video.

In some instances, the object 2808 may be located at different parts of the video, such as in a first part between frames at 7 to 10 seconds and a second part between frames at 17 to 22 seconds. A data structure associated with a correct answer file, section, or field defines which pixels correspond to a successful completion of the challenge. In some embodiments, the video may not be paused. Instead, a user has to make a selection via the pointer 2806 as the video is playing. It should be appreciated that in some embodiments, the underlying video is not edited or otherwise modified, thereby preserving the creative indent of a creator/distributor while enabling a security challenge to be integrated.

In some examples, a user may move the pointer 2806 to the video too late such that the object 2808 is no longer displayed. As such, the frame would not be associated with any pixels that enable the challenge to be successfully completed. The application 2800 may be programmed to detect movement of the pointer 2806 off of the video screen, if a challenge has not be successfully completed, causing the video to rewind by a few frames to a few seconds to enable the user to complete the challenge.

In some embodiments, pausing of the video may cause one or more objects to be selectable. For example, the video of FIG. 28 may include a movie trailer. Pausing of the video causes the object 2808 to be selectable by the pointer 2806 via a display element. Other objects may also be selectable. The selectable objects are displayed as, for example, icons or other graphics over the video by the application 2800 (and/or the security proxy server 1608 and/or the application server 1604). A challenge may instruct a user to move one of the objects to another location. In the illustrated example of FIG. 28, the challenge may instruct a user to move the glass object 2808 to a hand of the performer. A data structure for an answer file, section, or field may define a solution where the pointer 2806 has to move to the glass object 2808, make a selection, and perform a drag option to a set of pixels corresponding to a hand of the performer.

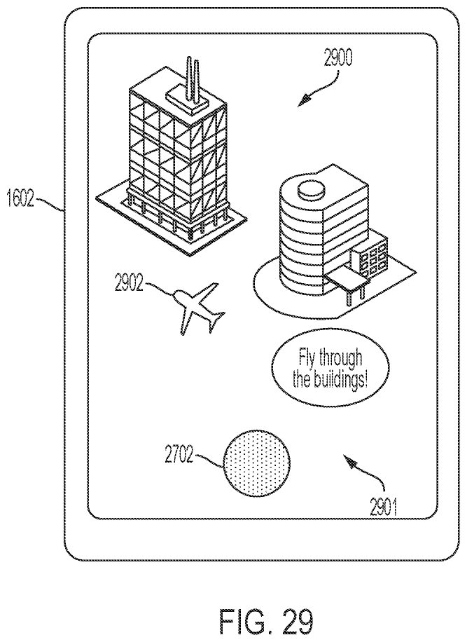

FIG. 29 shows an embodiment where a challenge is provided in a gaming application 2900 on a client device 1602, according to an example embodiment of the present disclosure. In the illustrated example, the application 2900 may be configured to provide the challenge. In other embodiments, the challenge may be provided by the security proxy server 1608 and/or the application server 1604. In yet other embodiments, the challenge may be provided by a security application 1702 operating on the client device 1602 or the application server 1604.

In the illustrated example, a user interface 2901 of the application 2900 provides a challenge where a pointer 2902 is rendered as, for example, an airplane. A prompt provides text indicating that a user has to navigate the pointer 2902 through buildings to complete the challenge. In some examples, the buildings may scroll as the user progress through them, where the application 2900 comprises a game. Successful navigation through the buildings causes the application 2900 (and/or the security proxy server 1608 and/or the application server 1604) to determine that the challenge was successfully completed. In the illustrated example, the application 2900 may include the interface element 2702 of FIG. 27 to provide control of the pointer 2902. In other examples, outputs from force sensors of the device 1602 may be used as the control.

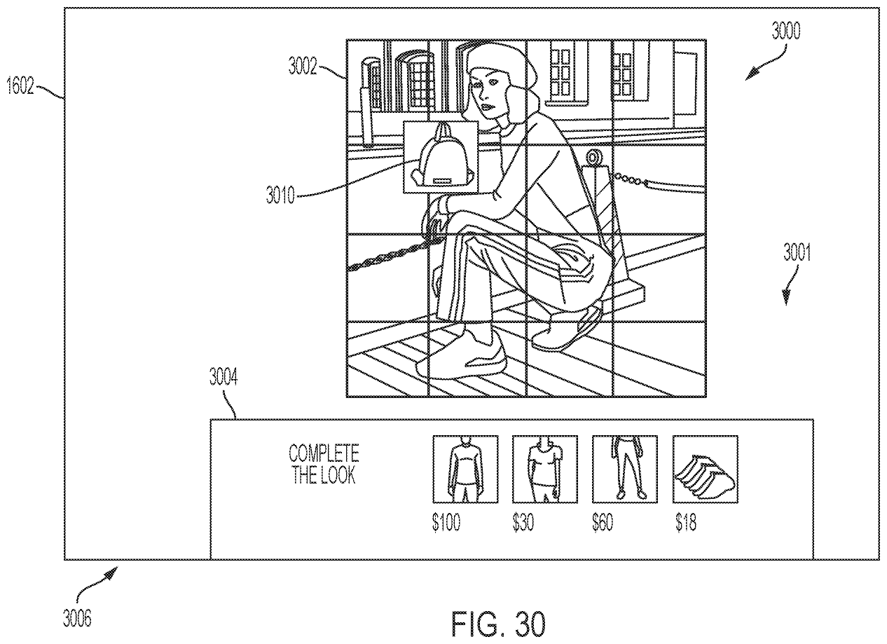

FIG. 30 shows an embodiment where a challenge is provided in a shopping application 3000 on a client device 1602, according to an example embodiment of the present disclosure. In the illustrated example, the application 3000 is configured to display an image 3002 and an advertising bar 3004 that shows one or more products. The image 3002 and/or the advertising bar 3004 may comprise a display element and be provided by an advertiser server, a host server, the security proxy server 1608 and/or the application server 1604. In yet other embodiments, the challenge may be provided by a security application 1702 operating on the client device 1602 and/or the application server 104.

As part of a check-out process, a user is provided with a challenge 3006 to use one or more objects in the advertising bar 3004 to complete the look of the person in the image 3002. The advertising bar 3004 may include one or more products or objects that relate to a product that was selected for purchase by a user as part of a check-out-process. In other examples, the advertising bar 3004 may include advertisements similar to an advertisement banner on a webpage, with advertisements selected by an ad-server (and/or the security proxy server 1608 and/or the application server 1604) based on a browsing history and/or geographic location of the user. In some examples, the security proxy server 1608 and/or the application server 1604 may analyze the selected advertisement and generate one or more graphical images that may be dragged by a user to a challenge location in the image 3002. The graphical images may also update a style or appearance of a pointer 3010 when selected in the advertising bar 3004.

Selection of an image in the advertising bar 3004 causes the application 3000 to change a display of a pointer 3010 to a graphical representation of the selected item/object. A user is instructed to place the objects on the person in the image 3002, where a data structure of an answer file or field may include coordinates of successful object placement. Placement of each object on the image 3002 may cause the application 3000 (and/or the security proxy server 1608 and/or the application server 1604) to change the image such that an image of the person wearing the placed object is displayed. In other examples, the application 3000 (and/or the security proxy server 1608 and/or the application server 1604) may modify the image 3002 to provide a rendering with the placed object. Placement of one or more of the objects in the advertising bar 3004 causes the application 3000 (and/or the security proxy server 1608 and/or the application server 1604) to determine the challenge was successfully completed.

In some embodiments, the application 3000 (and/or the security proxy server 1608 and/or the application server 1604) may cause a different image, video, or animation to be displayed upon determining that a challenge was successfully completed. For example, after the challenge of FIG. 30 is completed, an image or video of the person in, for example, a sporting event may be displayed. In another example, an animation is provided where the person in the image drives off on a moped before and/or while a checkout page is being displayed. In some examples, the images, animation, and/or video may be provided by sponsors and/or advertisers.

In the above embodiments, challenges for bot deterrence are provided for operations with various webpages and/or applications. The challenges may be completed relatively quickly by a human, while at the same time being insolvable by a bot within an allotted time. The challenges and framework disclosed herein enable content or application providers to provide robust website/application bot countermeasures, and in some cases, a source of additional revenue through security-based advertisement placement.

### CONCLUSION

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

For some embodiments of the disclosed technology, including those depicted in the figures, the soft presentation information of the pointer may be dependent on time since start of session, user interactions, (x,y) position while preserving the look and feel of the original page, preserving functionality of the original page, and therefore preserving the hard information of the session/application. For some embodiments of the disclosed technology, including those depicted in the figures, the soft response information of the pointer may also be dependent on time since start of session, user interactions, and (x,y) position, while preserving the look and feel and functionality of the original page. For some embodiments of the disclosed technology, including those depicted in the figures, soft information changes of the page/application environment in which the pointer acts may also be enabled subject to the constraints that the hard information required for the client and server to transmit and receive data in order to fulfill the intended use case of the application are preserved.

One or more aspects or features of the subject matter described herein can be realized in digital electronic circuitry, integrated circuitry, specially designed application specific integrated circuits (“ASICs”), field programmable gate arrays (“FPGAs”) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include client devices and servers. A client device and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

To provide for interaction with a user, one or more aspects or features of the subject matter described herein can be implemented on a computer having a display device, such as for example a cathode ray tube (“CRT”) or a liquid crystal display (“LCD”) or a light emitting diode (“LED”) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

The invention is claimed as follows:

1. A bot security apparatus comprising:
a memory device storing a plurality of challenge files for determining if a webpage user is a human or a bot, each of the challenge files including a display element, a user prompt, pointer information, and a location of the display element that corresponds to a correct response;
a security processor communicatively coupled to the memory device, the security processor configured to:
receive an indication message that a webpage of an application server is to be transmitted to a client device,
select a challenge file from the memory device,
transmit at least some information from the challenge file to cause the display element and the user prompt to be displayed on the client device and a pointer to be changed as specified by the pointer information,
receive a response message corresponding to at least one of a pointer selection or pointer movement made by the changed pointer at the client device in relation to the display element,
compare information within the response message to the location corresponding to the correct response for the selected challenge file,
if the information within the response message matches or is included within the location corresponding to the correct response for the selected challenge file, transmit a correct answer message, and
if the information within the response message does not match or is not included within the location corresponding to the correct response for the selected challenge file, transmit an incorrect answer message.

2. The apparatus of claim 1, wherein the indication message is received from the application server or a load balancer and includes an identifier of a generic challenge that is related to the webpage, and
wherein the challenge file selected by the security processor corresponds to the generic challenge and the at least some of the information from the challenge file is transmitted to the application server or the load balancer for replacement of the generic challenge.

3. The apparatus of claim 1, wherein the indication message is received from the application server and includes the webpage and a generic challenge,
wherein the challenge file selected by the security processor corresponds to the generic challenge, and
wherein the security processor replaces the generic challenge with the at least some of the information from the challenge file and transmits the at least some of the information from the challenge file to at least one of the client device or the application server.

4. The apparatus of claim 1, wherein the security processor transmits the correct answer message to the application server, which causes the application server to at least one of transmit the webpage to the client device, transmit a second webpage to the client device, or transmit content related to the webpage to the client device.

5. The apparatus of claim 1, wherein the security server transmits the incorrect answer message to the application server, which causes the application server to at least one of terminate a connection to the webpage with the client device, terminate a session with the client device, or block the client device.

6. The apparatus of claim 1, wherein the incorrect message includes at least some information from another challenge file that is selected by the security processor for display on the client device.

7. The apparatus of claim 1, wherein the display element and the user prompt are displayed in the webpage or in a popup window over the webpage.

8. The apparatus of claim 1, wherein the display element is specified in at least one of an image file, a video file, an audio file, a multimedia file, a Java file, or a plug-in file, and
wherein the display element shows at least one item comprising a person, an animal, a character, a scene, or a vehicle.

9. The apparatus of claim 8, wherein the display element includes instructions that cause at least part of the shown item to change in appearance in response to a mouse-over or hover by the pointer in relation to a location of the item shown in the display element.

10. The apparatus of claim 1, wherein locations of the display element are specified by coordinates and the location of the correct response includes at least one of a coordinate or a set of coordinates.

11. The apparatus of claim 1, wherein the pointer information includes at least one of a pointer file or instructions for changing properties of the pointer at the client device.

12. The apparatus of claim 1, wherein the pointer information is specified to correspond to the respective display element of the challenge file.

13. A machine-accessible device having instructions stored thereon that, when executed, cause a machine to at least:
select a challenge for display on a client device, the challenge including a display element, a user prompt, and stylized pointer information that corresponds to the display element;
provide the challenge causing the display element and the user prompt to be displayed on the client device and a pointer to be stylized as specified by the pointer information;
receive a response message corresponding to at least one of a pointer selection or pointer movement made by the stylized pointer at the client device in relation to the display element;
compare information within the response message to a specified correct location of the display element stored in an answer file or field that is related to the selected challenge;
if the information within the response message matches or is included within the specified correct location stored in the answer file or field, provide a correct answer message; and
if the information within the response message does not matches or is not included within the specified correct location stored in the answer file or field, provide an incorrect answer message.

14. The machine-accessible device of claim 13, wherein the challenge or the answer file or field includes a time threshold, and the machine-accessible device has instructions stored thereon that, when executed, cause the machine to at least:
start a timer when the challenge is provided;
if the response message is received before the elapsed time of the timer has reached the time threshold, perform the comparison that uses the information within the response message; and
if the elapsed time of the timer has reached or exceeded the time threshold, determine the challenge was not successfully completed and provide at least one of the incorrect message or a timeout message.

15. The machine-accessible device of claim 13, wherein the challenge or the answer file or field includes a click threshold, and the machine-accessible device has instructions stored thereon that, when executed, cause the machine to at least:
receive sequential multiple response messages, each response message including a location of the pointer during a pointer selection;
perform the comparison using the information within the earliest, sequentially received response messages that are below or meet the click threshold; and
disregard the response messages that sequentially exceed the click threshold.

16. The machine-accessible device of claim 13, wherein the response message includes an identifier of the selected challenge, and wherein the identifier is used to determine the answer file or field for the comparison that uses the information within the response message.

17. The machine-accessible device of claim 13, having instructions stored thereon that, when executed, cause the machine to at least:
determine a generic challenge related to at least one of a webpage or online content for the client device;
select the challenge based on the generic challenge; and
cause the generic challenge to be replaced with the selected challenge.

18. The machine-accessible device of claim 17, having instructions stored thereon that, when executed, cause the machine to at least provide at least one of the correct answer message or the incorrect answer message to an application server that at least one of (i) hosts the webpage or the online content for the client device, or (ii) transmits the webpage or the online content to the client device.

19. The machine-accessible device of claim 17, wherein the generic challenge includes metadata identifying content for the challenge, and wherein the challenge is selected based on the metadata.

20. The machine-accessible device of claim 19, wherein the content identified by the metadata includes at least one of advertising content, a person's name, a product brand, or a challenge type.

21. The machine-accessible device of claim 13, wherein providing the correct answer message causes at least one of a webpage or content to be provided to or displayed on the client device.
